(19) United States
(12) Patent Application Publication
(10) Pub. No.: US 2023/0161027 A1
(43) Pub. Date: May 25, 2023

(54) Smart-Device-Based Radar System Performing Near-Range Detection

(71) Applicant: Google LLC, Mountain View, CA (US)

(72) Inventors: Patrick M. Amihood, Palo Alto, CA (US); Cody Blair Wortham, San Francisco, CA (US)

(73) Assignee: Google LLC, Mountain View, CA (US)

(21) Appl. No.: 17/905,436

(22) PCT Filed: Mar. 4, 2020
(86) PCT No.: PCT/US2020/021009

§ 371 Date: Sep. 1, 2022

(51) Int. Cl. G01S 13/58; G01S 7/02; G01S 7/41

(52) U.S. Cl. CPC G01S 13/581; G01S 7/023; G01S 7/415

(57) ABSTRACT

Techniques and apparatuses are described that implement a smart-device-based radar system capable of performing near-range detection. The radar system employs a near-range detection module for detecting objects at near ranges in the presence of interference and a far-range detection module for detecting objects at far ranges. By evaluating separate range intervals, these modules can be designed to achieve a target false-alarm rate and detection performance by tailoring their processing to general characteristics of objects and interference at their respective range intervals. This enables the near-range detection module to detect a near-range object without generating a false detection associated with the interference. By utilizing the near-range detection module and the far-range detection module, the radar system can detect objects at both near and far ranges while achieving a target false-alarm rate.

### BACKGROUND

Radars are useful devices that can detect objects. Relative to other types of sensors, like a camera, a radar can provide improved performance in the presence of different environmental conditions, such as low lighting and fog, or with moving or overlapping objects. Radar can also detect objects through one or more occlusions, such as a purse or a pocket. While radar has many advantages, there are many challenges associated with integrating radar in consumer devices. These challenges include size and layout constraints of the consumer device, internal interference generated by other components within the consumer device, and external interference generated by other consumer devices.

### SUMMARY

Techniques and apparatuses are described that implement a smart-device-based radar system capable of performing near-range detection. The radar system employs separate modules for detecting objects at different range intervals. In particular, the radar system includes a near-range detection module for detecting objects at near ranges in the presence of interference and a far-range detection module for detecting objects at far ranges. By evaluating separate range intervals, these modules can be designed to achieve a target false-alarm rate and detection performance by tailoring their processing to general characteristics of objects and interference at their respective range intervals.

For example, the near-range detection module can distinguish between an interference artifact at near ranges and a near-range object by evaluating differences in range rates, signal-to-noise ratios, or spatial coverages. To identify the near-range object, the near-range detection module processes detections within low-Doppler bins, processes detections with amplitudes that are greater than or equal to a near-range threshold, and/or processes detections associated with a near-range spatial coverage. In this way, the near-range detection module can filter (e.g., not process) an interference artifact that is within high-Doppler bins, has an amplitude that is less than the near-range threshold, and/or is not associated with the near-range spatial coverage. Using these techniques, the near-range detection module can successfully detect the near-range object without generating a false detection associated with the interference artifact.

In contrast to the near-range detection module, the far-range detection module processes detections within high-Doppler bins, processes detections with amplitudes that are greater than or equal to a far-range threshold, which is less than the near-range threshold, and/or processes detections associated with a far-range spatial coverage. In some implementations, the near-range detection module can be dynamically enabled or disabled depending on the behavior of objects detected by the far-range detection module or an indication from a proximity sensor (e.g., a camera or an infrared sensor). By utilizing the near-range detection module and the far-range detection module, the radar system can detect objects at both near and far ranges while achieving a target false-alarm rate.

Aspects described below include a method performed by a radar system. The method includes transmitting radar transmit signals using an antenna array of the radar system and receiving radar receive signals using the antenna array. The radar receive signals comprise respective reflected versions of the radar transmit signals. The radar transmit signals are reflected by a user. The method also includes generating range-Doppler maps based on the radar receive signals and processing far-range portions of the range-Doppler maps using a far-range detection module of the radar system. The method additionally includes detecting, within the far-range portions of a set of the range-Doppler maps, the user approaching the smart device. The method further includes processing near-range portions of the range-Doppler maps using a near-range detection module of the radar system. The near-range portions of the range-Doppler maps includes at least one interference artifact. The processing is effective to filter the at least one interference artifact from the near-range portions of the range-Doppler maps. The method also includes detecting, within the near-range portions of another set of the range-Doppler maps, the user interacting with the smart device.

Aspects described below also include an apparatus with a radar system. The radar system includes an antenna array and a transceiver. The radar system also includes a processor and computer-readable storage media configured to perform any of the methods described herein.

Aspects described below also include a radar system with means for performing near-range detection.

### BRIEF DESCRIPTION OF THE DRAWINGS

Apparatuses for and techniques implementing a smart-device-based radar system capable of performing near-range detection are described with reference to the following drawings. The same numbers are used throughout the drawings to reference like features and components:

FIG. 1 illustrates example environments in which a smart-device-based radar system capable of performing near-range detection can be implemented.

FIG. 2-1 illustrates an example implementation of a radar system as part of a smart device.

FIG. 2-2 illustrates an example location of a radar system relative to other components within a smartphone.

FIG. 3-1 illustrates an operation of an example radar system.

FIG. 3-2 illustrates an example radar framing structure.

FIG. 4 illustrates an example antenna array and an example transceiver of a radar system.

FIG. 5 illustrates an example scheme implemented by a radar system for performing near-range detection.

FIG. 6 illustrates an example portion of a hardware-abstraction module for performing near-range detection.

FIG. 7 illustrates an example range-Doppler map for performing near-range detection.

FIG. 8-1 illustrates an example scheme implemented by a range-windowing module, a far-range detection module, and a near-range detection module.

FIG. 8-2 illustrates an example implementation of a near-range detection module.

FIG. 8-3 illustrates an example implementation of a far-range detection module.

FIG. 9 illustrates an example method of a radar system for performing near-range detection.

FIG. 10 illustrates an example computing system embodying, or in which techniques may be implemented that enable use of, a radar system capable of performing near-range detection.

### DETAILED DESCRIPTION

Overview

Integrating a radar system within an electronic device can be challenging. One such challenge involves size or layout constraints of the electronic device, which may limit where the radar system can be placed relative to other components within the electronic device. In some cases, these components generate interference, which can be detected by the radar system. This interference can include, for instance, an audible sound produced by a speaker of the electronic device or a wireless communication signal transmitted by a wireless transceiver of the electronic device. The radar system can also detect interference (e.g., another wireless communication signal or a radar signal) that is generated from another electronic device.

These types of interference can generate an interference artifact at near ranges, which can make it challenging for the radar system to detect near-range objects and achieve a target false-alarm rate. To the radar system, the interference artifact can appear to be one or more moving objects within a near-range portion of the radar system's range-Doppler map. If the interference artifact is not filtered, some radar systems may generate a false detection (or a false alarm) based on the interference artifact. A false detection or false alarm represents an erroneous detection that does not correspond to an object of interest. It can be challenging for the radar system to detect objects of interest (e.g., desired objects) that are in the far-range portion or the near-range portion of the range-Doppler map without generating a false detection based on the interference artifact. As such, evaluating the near-range portion of the range-Doppler map can increase the radar system's false-alarm rate and degrade the performance of the radar system.

To avoid increasing the false-alarm rate, some radar systems may not process the near-range portion of the range-Doppler map. Although this enables the radar system to avoid generating false detections based on the interference artifact, the radar system is unable to detect an object at near ranges. Consequently, this limits the volume of space in which the radar system can detect a desired object and therefore limits effective operation of the radar system.

In contrast, this document describes techniques and devices that implement a smart-device-based radar system capable of performing near-range detection. The radar system employs separate modules for detecting objects at different range intervals. In particular, the radar system includes a near-range detection module for detecting objects at near ranges in the presence of interference and a far-range detection module for detecting objects at far ranges. By evaluating separate range intervals, these modules can be designed to achieve a target false-alarm rate and detection performance by tailoring their processing to general characteristics of objects and interference at their respective range intervals.

For example, the near-range detection module can distinguish between an interference artifact at near ranges and a near-range object by evaluating differences in range rates, signal-to-noise ratios, or spatial coverages. To identify the near-range object, the near-range detection module processes detections within low-Doppler bins, processes detections with amplitudes that are greater than or equal to a near-range threshold, and/or processes detections associated with a near-range spatial coverage. In this way, the near-range detection module can filter (e.g., not process) an interference artifact that is within high-Doppler bins, has an amplitude that is less than the near-range threshold, and/or is not associated with the near-range spatial coverage. Using these techniques, the near-range detection module can successfully detect the near-range object without generating a false detection associated with the interference artifact.

In contrast to the near-range detection module, the far-range detection module processes detections within high-Doppler bins, processes detections with amplitudes that are greater than or equal to a far-range threshold, which is less than the near-range threshold, and/or processes detections associated with a far-range spatial coverage. In some implementations, the near-range detection module can be dynamically enabled or disabled depending on the behavior of objects detected by the far-range detection module or an indication from a proximity sensor (e.g., a camera or an infrared sensor). By utilizing the near-range detection module and the far-range detection module, the radar system can detect objects at both near and far ranges while achieving a target false-alarm rate.

For example, a range-Doppler map can comprise an array of cells, each cell being associated with one of a plurality of range bins and with one of a plurality of Doppler bins, each range bin corresponding to a particular range interval, and each Doppler bin corresponding to a particular Doppler frequency interval.

Example Environment

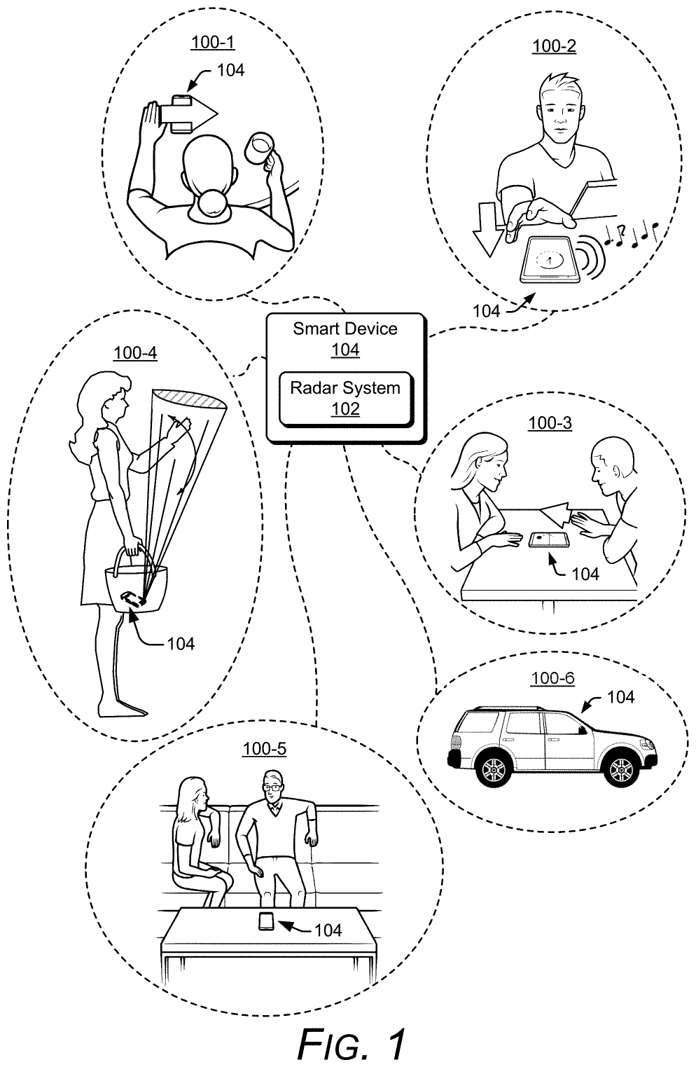

FIG. 1 is an illustration of example environments 100-1 to 100-6 in which techniques using, and an apparatus including, a smart-device-based radar system capable of performing near-range detection may be embodied. In the depicted environments 100-1 to 100-6, a radar system 102 of a smart device 104 is capable of detecting one or more objects (e.g., users). The smart device 104 is shown to be a smartphone in environments 100-1 to 100-5 and a smart vehicle in the environment 100-6. In general, the smart device 104 may, e.g., be a user device comprising a computer processor and computer-readable media.

In the environments 100-1 to 100-4, a user performs different types of gestures, which are detected by the radar system 102. In some cases, the user performs a gesture using an appendage or body part. Alternatively, the user can also perform a gesture using a stylus, a hand-held object, a ring, or any type of material that can reflect radar signals.

In environment 100-1, the user makes a scrolling gesture by moving a hand above the smart device 104 along a horizontal dimension (e.g., from a left side of the smart device 104 to a right side of the smart device 104). In the environment 100-2, the user makes a reaching gesture, which decreases a distance between the smart device 104 and the user's hand. The users in environment 100-3 make hand gestures to play a game on the smart device 104. In one instance, a user makes a pushing gesture by moving a hand above the smart device 104 along a vertical dimension (e.g., from a bottom side of the smart device 104 to a top side of the smart device 104). In the environment 100-4, the smart device 104 is stored within a purse, and the radar system 102 provides occluded-gesture recognition by detecting gestures that are occluded by the purse.

The radar system 102 can also recognize other types of gestures or motions not shown in FIG. 1. Example types of gestures include a knob-turning gesture in which a user curls their fingers to grip an imaginary doorknob and rotate their fingers and hand in a clockwise or counter-clockwise fashion to mimic an action of turning the imaginary doorknob. Another example type of gesture includes a spindle-twisting gesture, which a user performs by rubbing a thumb and at least one other finger together. The gestures can be two-dimensional, such as those used with touch-sensitive displays (e.g., a two-finger pinch, a two-finger spread, or a tap). The gestures can also be three-dimensional, such as many sign-language gestures, e.g., those of American Sign Language (ASL) and other sign languages worldwide. Upon detecting each of these gestures, the smart device 104 can perform an action, such as display new content, move a cursor, activate one or more sensors, open an application, and so forth. In this way, the radar system 102 provides touch-free control of the smart device 104.

In the environment 100-5, the radar system 102 generates a three-dimensional map of a surrounding environment for contextual awareness. The radar system 102 also detects and tracks multiple users to enable both users to interact with the smart device 104. The radar system 102 can also perform vital-sign detection. In the environment 100-6, the radar system 102 monitors vital signs of a user that drives a vehicle. Example vital signs include a heart rate and a respiration rate. If the radar system 102 determines that the driver is falling asleep, for instance, the radar system 102 can cause the smart device 104 to alert the user. Alternatively, if the radar system 102 detects a life threatening emergency, such as a heart attack, the radar system 102 can cause the smart device 104 to alert a medical professional or emergency services.

In the environments 100-1 to 100-6, the radar system 102 can detect both near-range objects and far-range objects. This enables the radar system 102 to detect a gesture that traverses from a far range to a near range or a user's face that is within a near range from the smart device 104. By detecting objects within the near range, the radar system 102 can reliably control the smart device 104. For example, the radar system 102 can conserve power or transition to a lock screen responsive to determining that the user is not present within the near range.

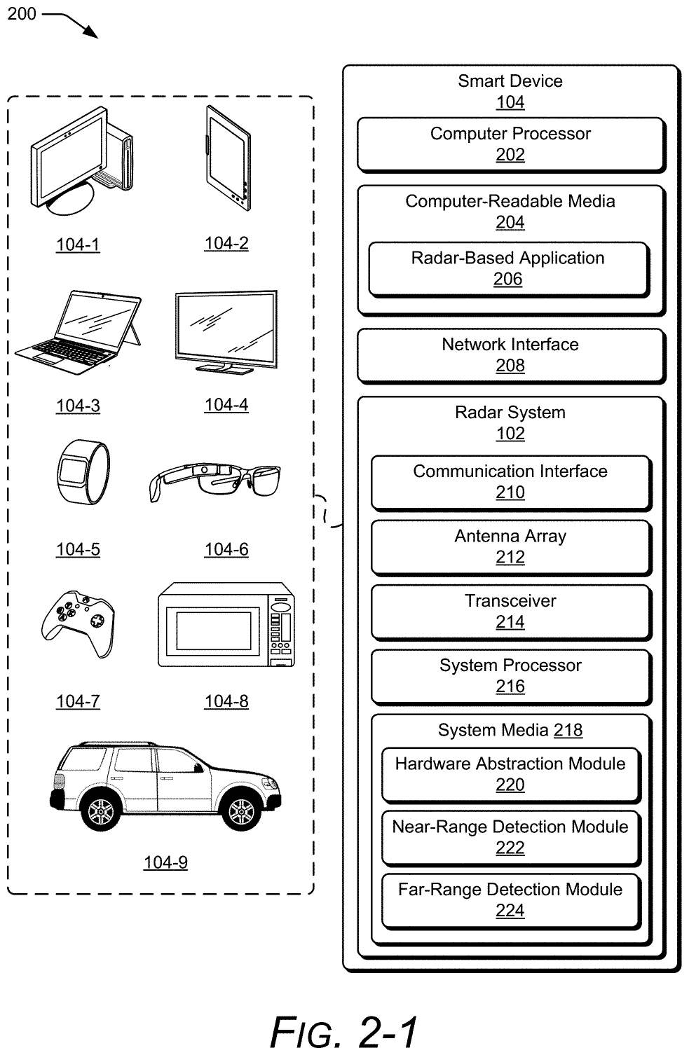

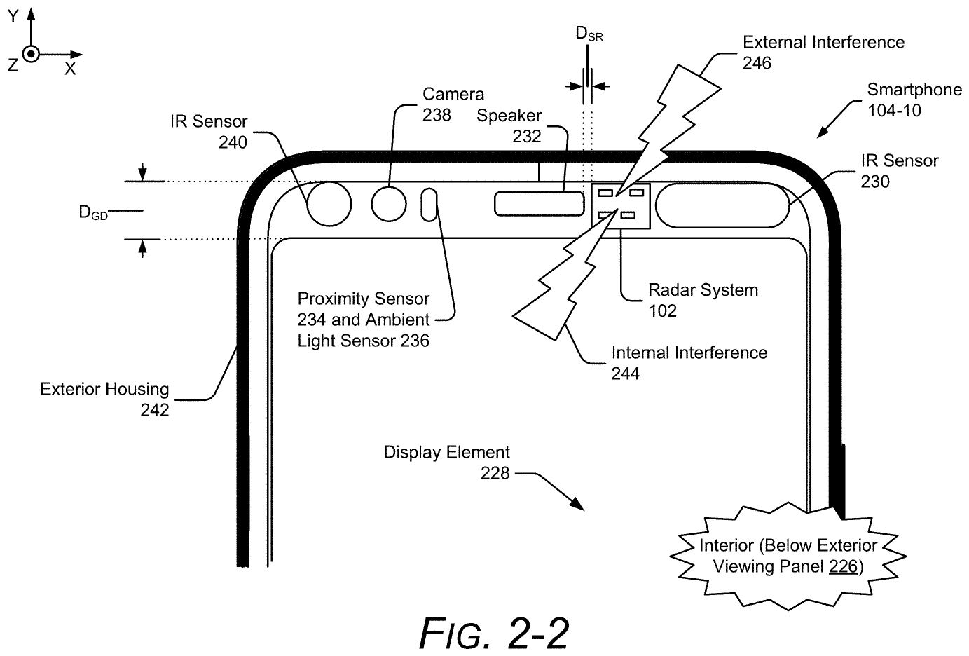

Some implementations of the radar system 102 are particularly advantageous as applied in the context of smart devices 104, for which there is a convergence of issues. This can include a need for limitations in a spacing and layout of the radar system 102 and low power. Exemplary overall lateral dimensions of the smart device 104 can be, for example, approximately eight centimeters by approximately fifteen centimeters. Exemplary footprints of the radar system 102 can be even more limited, such as approximately four millimeters by six millimeters with antennas included. Exemplary power consumption of the radar system 102 may be on the order of a few milliwatts to tens of milliwatts (e.g., between approximately two milliwatts and twenty milliwatts). The requirement of such a limited footprint and power consumption for the radar system 102 enables the smart device 104 to include other desirable features in a space-limited package (e.g., a camera sensor, a fingerprint sensor, a display, and so forth). The smart device 104 and the radar system 102 are further described with respect to FIG. 2-1.

FIG. 2-1 illustrates the radar system 102 as part of the smart device 104. The smart device 104 is illustrated with various non-limiting example devices including a desktop computer 104-1, a tablet 104-2, a laptop 104-3, a television 104-4, a computing watch 104-5, computing glasses 104-6, a gaming system 104-7, a microwave 104-8, and a vehicle 104-9. Other devices may also be used, such as a home service device, a smart speaker, a smart thermostat, a security camera, a baby monitor, a router, a drone, a trackpad, a drawing pad, a netbook, an e-reader, a home-automation and control system, a wall display, and another home appliance. Note that the smart device 104 can be wearable, non-wearable but mobile, or relatively immobile (e.g., desktops and appliances). The radar system 102 can be used as a stand-alone radar system or used with, or embedded within, many different smart devices 104 or peripherals, such as in control panels that control home appliances and systems, in automobiles to control internal functions (e.g., volume, cruise control, or even driving of the car), or as an attachment to a laptop computer to control computing applications on the laptop.

The smart device 104 includes one or more computer processors 202 and computer-readable media 204, which includes memory media and storage media. Applications and/or an operating system (not shown) embodied as computer-readable instructions on the computer-readable media 204 can be executed by the computer processor 202 to provide some of the functionalities described herein. The computer-readable media 204 also includes a radar-based application 206, which uses radar data generated by the radar system 102 to perform a function, such as presence detection, gesture-based touch-free control, collision avoidance for autonomous driving, human vital-sign notification, and so forth.

The smart device 104 can also include a network interface 208 for communicating data over wired, wireless, or optical networks. For example, the network interface 208 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, and the like. The smart device 104 may also include a display (not shown).

The radar system 102 includes a communication interface 210 to transmit the radar data to a remote device, though this need not be used when the radar system 102 is integrated within the smart device 104. In general, the radar data provided by the communication interface 210 is in a format usable by the radar-based application 206.

The radar system 102 also includes at least one antenna array 212 and at least one transceiver 214 to transmit and receive radar signals. The antenna array 212 includes at least one transmit antenna element and at least one receive antenna element. In some situations, the antenna array 212 includes multiple transmit antenna elements to implement a multiple-input multiple-output (MIMO) radar capable of transmitting multiple distinct waveforms at a given time (e.g., a different waveform per transmit antenna element). The antenna elements can be circularly polarized, horizontally polarized, vertically polarized, or a combination thereof.

In some implementations, the antenna array 212 includes two or more receive antenna elements for digital beamforming. The receive antenna elements of the antenna array 212 can be positioned in a one-dimensional shape (e.g., a line) or a two-dimensional shape (e.g., a rectangular arrangement, a triangular arrangement, or an “L” shape arrangement) for implementations that include three or more receive antenna elements. The one-dimensional shape enables the radar system 102 to measure one angular dimension (e.g., an azimuth or an elevation) while the two-dimensional shape enables the radar system 102 to measure two angular dimensions (e.g., to determine both an azimuth angle and an elevation angle of the object). An element spacing associated with the receive antenna elements can be less than, greater than, or equal to half a center wavelength of the radar signal.

Using the antenna array 212, the radar system 102 can form beams that are steered or un-steered, wide or narrow, or shaped (e.g., hemisphere, cube, fan, cone, cylinder). The steering and shaping can be achieved through analog beamforming or digital beamforming. The one or more transmitting antenna elements can have, for instance, an un-steered omnidirectional radiation pattern or can produce a wide steerable beam to illuminate a large volume of space. To achieve target angular accuracies and angular resolutions, the receiving antenna elements can be used to generate hundreds or thousands of narrow steered beams with digital beamforming. In this way, the radar system 102 can efficiently monitor an external environment and detect one or more users.

The transceiver 214 includes circuitry and logic for transmitting and receiving radar signals via the antenna array 212. Components of the transceiver 214 can include amplifiers, mixers, switches, analog-to-digital converters, or filters for conditioning the radar signals. The transceiver 214 also includes logic to perform in-phase/quadrature (I/Q) operations, such as modulation or demodulation. A variety of modulations can be used, including linear frequency modulations, triangular frequency modulations, stepped frequency modulations, or phase modulations. Alternatively, the transceiver 214 can produce radar signals having a relatively constant frequency or a single tone. The transceiver 214 can be configured to support continuous-wave or pulsed radar operations.

A frequency spectrum (e.g., range of frequencies) that the transceiver 214 uses to generate the radar signals can encompass frequencies between 1 and 400 gigahertz (GHz), between 4 and 100 GHz, between 1 and 24 GHz, between 2 and 4 GHz, between 57 and 64 GHz, or at approximately 2.4 GHz. In some cases, the frequency spectrum can be divided into multiple sub-spectrums that have similar or different bandwidths. The bandwidths can be on the order of 500 megahertz (MHz), 1 GHz, 2 GHz, and so forth. Different frequency sub-spectrums may include, for example, frequencies between approximately 57 and 59 GHz, 59 and 61 GHz, or 61 and 63 GHz. Although the example frequency sub-spectrums described above are contiguous, other frequency sub-spectrums may not be contiguous. To achieve coherence, multiple frequency sub-spectrums (contiguous or not) that have a same bandwidth may be used by the transceiver 214 to generate multiple radar signals, which are transmitted simultaneously or separated in time. In some situations, multiple contiguous frequency sub-spectrums may be used to transmit a single radar signal, thereby enabling the radar signal to have a wide bandwidth.

The radar system 102 also includes one or more system processors 216 and a system media 218 (e.g., one or more computer-readable storage media). The system media 218 optionally includes a hardware-abstraction module 220. The system media 218 also includes a near-range detection module 222 and a far-range detection module 224. The hardware-abstraction module 220, the near-range detection module 222, and the far-range detection module 224 can be implemented using hardware, software, firmware, or a combination thereof. In this example, the system processor 216 implements the hardware-abstraction module 220, the near-range detection module 222, and the far-range detection module 224. Together, the hardware-abstraction module 220, the near-range detection module 222, and the far-range detection module enable the system processor 216 to process responses from the receive antenna elements in the antenna array 212 to detect a user, determine a position of the object, and/or recognize a gesture performed by the user.

In an alternative implementation (not shown), the hardware-abstraction module 220, the near-range detection module 222, and the far-range detection module 224 are included within the computer-readable media 204 and implemented by the computer processor 202. This enables the radar system 102 to provide the smart device 104 raw data via the communication interface 210 such that the computer processor 202 can process the raw data for the radar-based application 206.

The hardware-abstraction module 220 transforms raw data provided by the transceiver 214 into hardware-agnostic radar data, which can be processed by the near-range detection module 222 and the far-range detection module 224. In particular, the hardware-abstraction module 220 conforms complex radar data from a variety of different types of radar signals to an expected input of the near-range detection module 222 and the far-range detection module 224. This enables the near-range detection module 222 and the far-range detection module 224 to process different types of radar signals received by the radar system 102, including those that utilize different modulations schemes for frequency-modulated continuous-wave radar, phase-modulated spread spectrum radar, or impulse radar. The hardware-abstraction module 220 can also normalize complex radar data from radar signals with different center frequencies, bandwidths, transmit power levels, or pulsewidths.

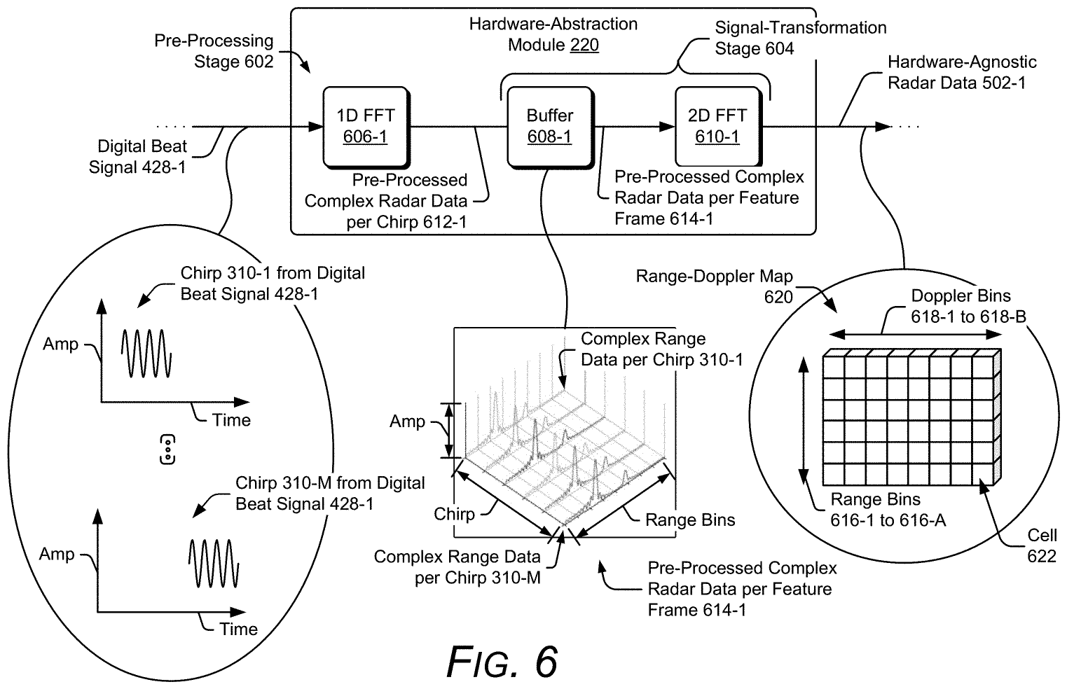

Additionally, the hardware-abstraction module 220 conforms complex radar data generated using different hardware architectures. Different hardware architectures can include different antenna arrays 212 positioned on different surfaces of the smart device 104 or different sets of antenna elements within an antenna array 212. By using the hardware-abstraction module 220, the near-range detection module 222 and the far-range detection module 224 can process complex radar data generated by different sets of antenna elements with different gains, different sets of antenna elements of various quantities, or different sets of antenna elements with different antenna element spacings. Furthermore, the hardware-abstraction module 220 enables the near-range detection module 222 and the far-range detection module 224 to operate in radar systems 102 with different limitations that affect the available radar modulation schemes, transmission parameters, or types of hardware architectures. The hardware-abstraction module 220 is further described with respect to FIG. 6. Both the near-range detection module 222 and the far-range detection module 224 can operate on the hardware-agnostic radar data provided by the hardware-abstraction module 220.

The near-range detection module 222 is designed to detect near-range objects in the presence of interference. To distinguish between an interference artifact at near ranges and a near-range object, the near-range detection module 222 utilizes general characteristics of the near-range object and the interference, which can differ. The near-range object, for example, can have a smaller range-rate relative to an interference artifact generated by the interference. This range rate enables the near-range object to avoid colliding with the smart device 104. Additionally or alternatively, the near-range object can have a large signal-to-noise ratio compared to the interference artifact. The near-range object can also be spatially large relative to the interference artifact and therefore have a large amplitude across multiple range bins or angular bins.

To identify the near-range object, the near-range detection module processes detections within low-Doppler bins, processes detections with amplitudes that are greater than or equal to a near-range threshold, and/or processes detections associated with a near-range spatial coverage. In this way, the near-range detection module can filter (e.g., not process) the interference artifact that is within high-Doppler bins, has an amplitude that is less than the near-range threshold, and/or is not associated with the near-range spatial coverage. Using these techniques, the near-range detection module can successfully detect the near-range object without generating a false detection associated with the interference artifact. The near-range detection module 222 is further described with respect to FIGS. 8-1 and 8-2.

The far-range detection module 224 is designed to detect far-range objects. Characteristics of a far-range object can differ from a near-range object. For example, the far-range object can have a larger range rate than the near-range object. Due to the far-range object being observed at farther ranges, the far-range object can also have a smaller signal-to-noise ratio than the near-range object and appear to be spatially smaller than the near-range object. Therefore, the far-range detection module 224 performs one or more different operations relative to the near-range detection module 222 in order to detect the far-range object. For example, the far-range detection module 224 processes detections within high-Doppler bins, processes detections with amplitudes that are greater than a far-range threshold, which is less than the near-range threshold, and/or processes detections associated with a far-range spatial coverage, which is smaller than the near-range spatial coverage. The far-range detection module 224 is further described with respect to FIGS. 8-1 and 8-3.

In some implementations, the near-range detection module 222 is dynamically enabled or disabled depending on the behavior of objects detected by the far-range detection module 224 or an indication from a proximity sensor (e.g., a camera or an infrared sensor). For example, the radar system 102 can enable the near-range detection module 222 if the far-range detection module 224 identifies an object that is approaching the near-range interval (e.g., moving towards the radar system 102 or the smart device 104). As another example, the proximity sensor enables the near-range detection module 222 if the proximity sensor detects the user.

The near-range detection module 222 produces near-range detection data, and the far-range detection module 224 produces far-range detection data, both of which can be further analyzed by the system processor 216. For example, the system processor 216 can process the near-range detection data and the far-range detection data to generate radar-application data for the radar-based application 206. Example types of radar-application data include presence of a user, position of the user, movement of the user, a type of gesture performed by the user, a measured vital-sign of the user, a collision alert, or characteristics of an object.

FIG. 2-2 illustrates an example location of the radar system 102 relative to other components within the smart device 104. In this example, the smart device 104 is shown to be a smartphone 104-10. An exterior of the smartphone 104-10 includes an exterior housing 242 and an exterior viewing panel 226. As an example, the exterior housing 242 has a vertical height of approximately 147 millimeters (mm), a horizontal length of approximately 69 mm, and a width of approximately 8 mm. The exterior housing 242 can be composed of metal material, for instance.

The exterior viewing panel 226 forms an exterior face of the smartphone 104-10 and has a vertical height of approximately 139 mm and a horizontal length of approximately 61 mm. The exterior viewing panel 226 includes cut-outs for various components that are positioned within an interior of the smartphone 104-10 (e.g., positioned beneath the exterior viewing panel 226). These components are further described below.

The exterior viewing panel 226 can be formed using various types of glass or plastics that are found within display screens. In some implementations, the exterior viewing panel 226 has a dielectric constant (e.g., a relative permittivity) between approximately four and ten, which attenuates or distorts radar signals. As such, the exterior viewing panel 226 is opaque or semi-transparent to a radar signal and can cause a portion of a transmitted or received radar signal to be reflected.

At least a portion of the radar system 102, such as an integrated circuit that includes the antenna array 212 and the transceiver 214, is positioned beneath the exterior viewing panel 226 and near an edge of the smartphone 104-10. As an example, the integrated circuit has a vertical height of approximately 5 mm, a horizontal length of approximately 6.5 mm, and a thickness of approximately 0.85 mm (within +/−0.1 mm along each dimension). These dimensions enable the integrated circuit to fit between the exterior housing 242 and a display element 228. The vertical height of the integrated circuit can be similar to other components that are positioned near the edge of the smartphone 104-10 so as to avoid reducing a size of the display element 228.

In this example implementation, the antenna array 212 is oriented towards (e.g., faces) the exterior viewing panel 226. As such, the integrated circuit radiates through the exterior viewing panel 226 (e.g., transmits and receives the radar signals that propagate through the exterior viewing panel 226). If the exterior viewing panel 226 behaves as an attenuator, the radar system 102 can adjust a frequency or a steering angle of a transmitted radar signal to mitigate the effects of the attenuator instead of increasing transmit power. As such, the radar system 102 can realize enhanced accuracy and longer ranges for detecting the user without increasing power consumption.

The display element 228 displays images that are viewed through the exterior viewing panel 226. As shown, the antenna array 212 of the radar system 102 is oriented towards (e.g., faces) a same direction as the display element 228 such that the radar system 102 transmits radar signals towards a user that is looking at the display element 228.

In this example, the radar system 102 transmits and receives radar signals with frequencies between approximately 57 and 64 GHz. This mitigates electromagnetic interference with a wireless communication system of the smartphone 104-10, which uses frequencies below 20 GHz, for instance. Transmitting and receiving radar signals with millimeter wavelengths further enables the integrated circuit of the radar system 102 to realize the above footprint.

A depicted interior of the smartphone 104-10 includes the integrated circuit of the radar system 102, the display element 228, an infrared sensor 230, a speaker 232, a proximity sensor 234, an ambient light sensor 236, a camera 238, and another infrared sensor 240. The integrated circuit of the radar system 102, the infrared sensor 230, the speaker 232, the proximity sensor 234, the ambient light sensor 236, the camera 238, and the infrared sensor 240 are positioned beneath an upper portion of the exterior viewing panel 226. The display element 228 is positioned beneath the lower portion of the exterior viewing panel 226. In this example, a distance between a top edge of the display element 228 and a top edge of the exterior viewing panel 226 (D_{GD}) is approximately 6.2 mm.

The infrared sensors 230 and 240 can be used for facial recognition. To conserve power, the infrared sensors 230 and 240 operate in an off-state when not in use. However, a warm-up sequence associated with transitioning the infrared sensors 230 and 240 from the off-state to an on-state can require a significant amount of time, such as a half-second or more. This can cause a delay in execution of the facial recognition. To reduce this time delay, the radar system 102 proactively detects the user reaching towards or approaching the smartphone 104-10 and initiates the warm-up sequence prior to the user touching the smartphone 104-10. As such, the infrared sensors 230 and 240 can be in the on-state sooner and reduce a time the user waits for the facial recognition to complete.

In this example, the integrated circuit of the radar system 102 is positioned between the infrared sensor 230 and the speaker 232. A distance between the integrated circuit and the speaker 232 (D_{SR}) is approximately 0.93 mm or less. As such, the radar system 102 is within close proximity to the speaker 232 and can vibrate while the speaker 232 produces audible sounds.

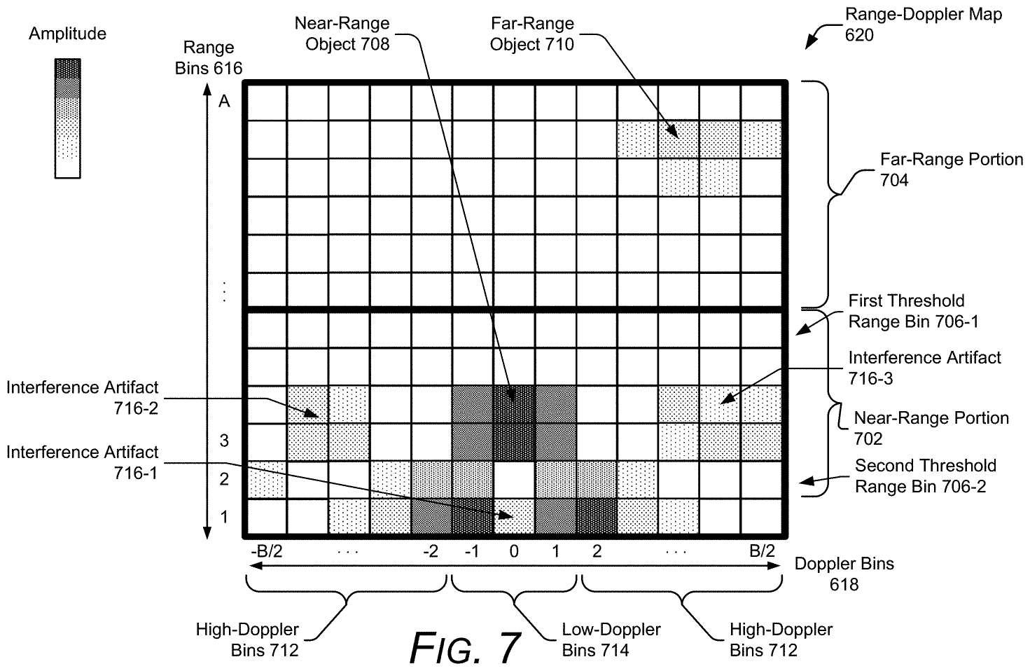

The radar system 102 can detect internal interference 244, which is generated by components within the smartphone 104-10, or external interference 246, which is generated by an external device, such as another smartphone. Example types of internal interference 244 include audible sounds produced by the speaker 232, wireless communication signals generated by a wireless transceiver (not shown) of the smartphone 104-10, or noise that propagates along a power line, which supplies power to the radar system 102. Another type of internal interference 244 includes the cross-coupling within the antenna array 212 of the radar system 102. The external interference 246 can include other audible sounds within the external environment, other wireless communication signals transmitted by other devices, or other radar signals generated by radar systems of other devices. Both the internal interference 244 and the external interference 246 can produce interference artifacts that are detected by the radar system 102 within the near range or the far range, as further described with respect to FIG. 7. By using separate detection modules that are tailored to different range intervals, the radar system 102 can filter the interference artifacts to achieve the target false alarm rate.

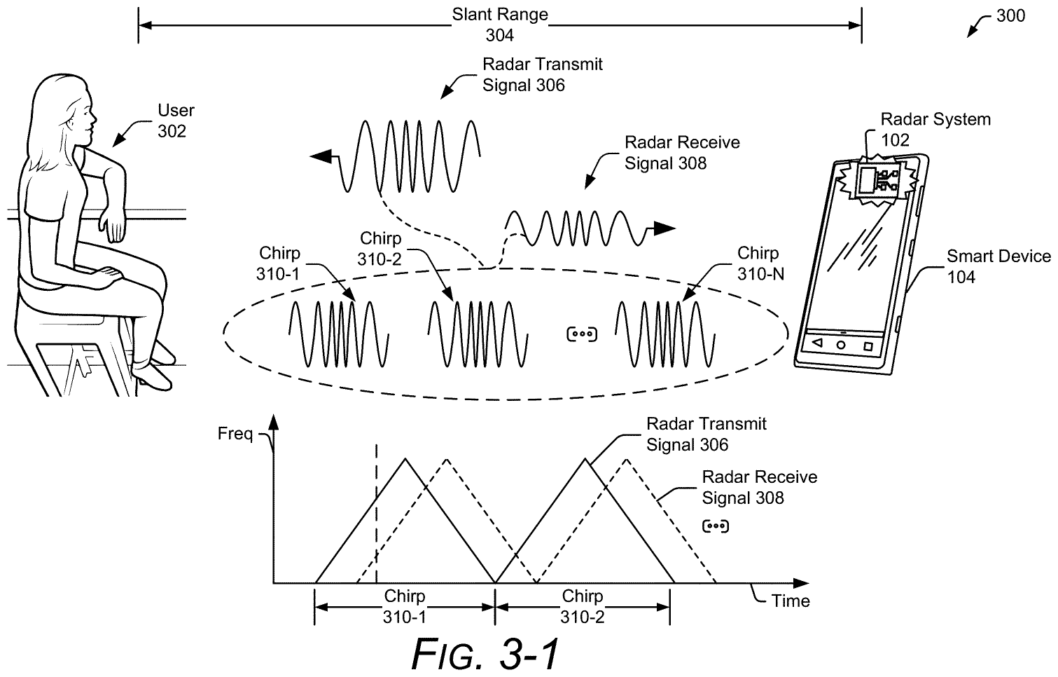

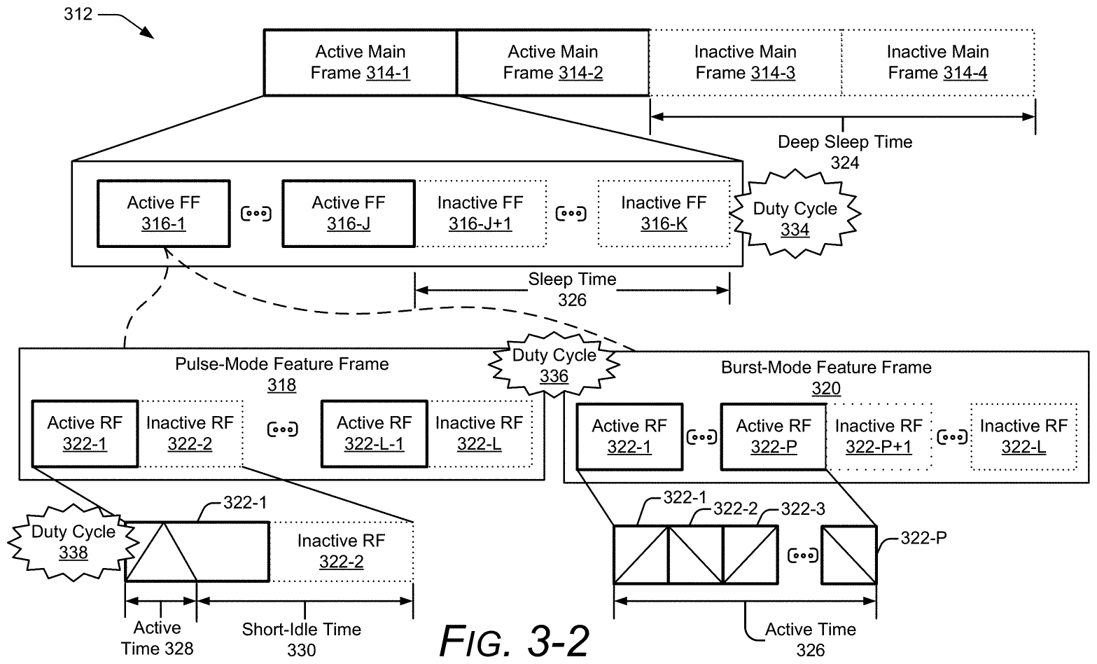

FIG. 3-1 illustrates an example operation of the radar system 102. In the depicted configuration, the radar system 102 is implemented as a frequency-modulated continuous-wave radar. However, other types of radar architectures can be implemented, as described above with respect to FIG. 2-1. In environment 300, a user 302 is located at a particular slant range 304 from the radar system 102. To detect the user 302, the radar system 102 transmits a radar transmit signal 306. At least a portion of the radar transmit signal 306 is reflected by the user 302. This reflected portion represents a radar receive signal 308. The radar system 102 receives the radar receive signal 308 and processes the radar receive signal 308 to extract data for the radar-based application 206. As depicted, an amplitude of the radar receive signal 308 is smaller than an amplitude of the radar transmit signal 306 due to losses incurred during propagation and reflection.

The radar transmit signal 306 includes a sequence of chirps 310-1 to 310-N, where N represents a positive integer greater than one. The radar system 102 can transmit the chirps 310-1 to 310-N in a continuous burst or transmit the chirps 310-1 to 310-N as time-separated pulses, as further described with respect to FIG. 3-2. A duration of each chirp 310-1 to 310-N can be on the order of tens or thousands of microseconds (e.g., between approximately 30 microseconds (μs) and 5 milliseconds (ms)), for instance.

Individual frequencies of the chirps 310-1 to 310-N can increase or decrease over time. In the depicted example, the radar system 102 employs a two-slope cycle (e.g., triangular frequency modulation) to linearly increase and linearly decrease the frequencies of the chirps 310-1 to 310-N over time. The two-slope cycle enables the radar system 102 to measure the Doppler frequency shift caused by motion of the user 302. In general, transmission characteristics of the chirps 310-1 to 310-N (e.g., bandwidth, center frequency, duration, and transmit power) can be tailored to achieve a particular detection range, range resolution, or doppler sensitivity for detecting one or more characteristics the user 302 or one or more actions performed by the user 302.

At the radar system 102, the radar receive signal 308 represents a delayed version of the radar transmit signal 306. The amount of delay is proportional to the slant range 304 (e.g., distance) from the antenna array 212 of the radar system 102 to the user 302. In particular, this delay represents a summation of a time it takes for the radar transmit signal 306 to propagate from the radar system 102 to the user 302 and a time it takes for the radar receive signal 308 to propagate from the user 302 to the radar system 102. If the user 302 and/or the radar system 102 is moving, the radar receive signal 308 is shifted in frequency relative to the radar transmit signal 306 due to the Doppler effect. In other words, characteristics of the radar receive signal 308 are dependent upon motion of the hand and/or motion of the radar system 102. Similar to the radar transmit signal 306, the radar receive signal 308 is composed of one or more of the chirps 310-1 to 310-N.

The multiple chirps 310-1 to 310-N enable the radar system 102 to make multiple observations of the user 302 over a predetermined time period. A radar framing structure determines a timing of the chirps 310-1 to 310-N, as further described with respect to FIG. 3-2.

FIG. 3-2 illustrates an example radar framing structure 312 for near-range detection. In the depicted configuration, the radar framing structure 312 includes three different types of frames. At a top level, the radar framing structure 312 includes a sequence of main frames 314, which can be in the active state or the inactive state. Generally speaking, the active state consumes a larger amount of power relative to the inactive state. At an intermediate level, the radar framing structure 312 includes a sequence of feature frames 316, which can similarly be in the active state or the inactive state. Different types of feature frames 316 include a pulse-mode feature frame 318 (shown at the bottom-left of FIG. 3-2) and a burst-mode feature frame 320 (shown at the bottom-right of FIG. 3-2). At a low level, the radar framing structure 312 includes a sequence of radar frames (RF) 322, which can also be in the active state or the inactive state.

The radar system 102 transmits and receives a radar signal during an active radar frame 322. In some situations, the radar frames 322 are individually analyzed for basic radar operations, such as search and track, clutter map generation, user location determination, and so forth. Radar data collected during each active radar frame 322 can be saved to a buffer after completion of the radar frame 322 or provided directly to the system processor 216 of FIG. 2.

The radar system 102 analyzes the radar data across multiple radar frames 322 (e.g., across a group of radar frames 322 associated with an active feature frame 316) to identify a particular feature. Example types of features include a particular type of motion, a motion associated with a particular appendage (e.g., a hand or individual fingers), and a feature associated with different portions of the gesture. To detect a change in the radar system 102's frame of reference or recognize a gesture performed by the user 302 during an active main frame 314, the radar system 102 analyzes the radar data associated with one or more active feature frames 316.

A duration of the main frame 314 may be on the order of milliseconds or seconds (e.g., between approximately 10 ms and 10 seconds (s)). After active main frames 314-1 and 314-2 occur, the radar system 102 is inactive, as shown by inactive main frames 314-3 and 314-4. A duration of the inactive main frames 314-3 and 314-4 is characterized by a deep sleep time 324, which may be on the order of tens of milliseconds or more (e.g., greater than 50 ms). In an example implementation, the radar system 102 turns off all of the active components (e.g., an amplifier, an active filter, a voltage-controlled oscillator (VCO), a voltage-controlled buffer, a multiplexer, an analog-to-digital converter, a phase-lock loop (PLL) or a crystal oscillator) within the transceiver 214 to conserve power during the deep sleep time 324.

In the depicted radar framing structure 312, each main frame 314 includes K feature frames 316, where K is a positive integer. If the main frame 314 is in the inactive state, all of the feature frames 316 associated with that main frame 314 are also in the inactive state. In contrast, an active main frame 314 includes J active feature frames 316 and K-J inactive feature frames 316, where J is a positive integer that is less than or equal to K. A quantity of feature frames 316 can be adjusted based on a complexity of the environment or a complexity of a gesture. For example, a main frame 314 can include a few to a hundred feature frames 316 (e.g., K may equal 2, 10, 30, 60, or 100). A duration of each feature frame 316 may be on the order of milliseconds (e.g., between approximately 1 ms and 50 ms).

To conserve power, the active feature frames 316-1 to 316-J occur prior to the inactive feature frames 316-(J+1) to 316-K. A duration of the inactive feature frames 316-(J+1) to 316-K is characterized by a sleep time 326. In this way, the inactive feature frames 316-(J+1) to 316-K are consecutively executed such that the radar system 102 can be in a powered-down state for a longer duration relative to other techniques that may interleave the inactive feature frames 316-(J+1) to 316-K with the active feature frames 316-1 to 316-J. Generally speaking, increasing a duration of the sleep time 326 enables the radar system 102 to turn off components within the transceiver 214 that require longer start-up times.

Each feature frame 316 includes L radar frames 322, where L is a positive integer that may or may not be equal to J or K. In some implementations, a quantity of radar frames 322 may vary across different feature frames 316 and may comprise a few frames or hundreds of frames (e.g., L may equal 5, 15, 30, 100, or 500). A duration of a radar frame 322 may be on the order of tens or thousands of microseconds (e.g., between approximately 30 μs and 5 ms). The radar frames 322 within a particular feature frame 316 can be customized for a predetermined detection range, range resolution, or doppler sensitivity, which facilitates detection of a particular feature or gesture. For example, the radar frames 322 may utilize a particular type of modulation, bandwidth, frequency, transmit power, or timing. If the feature frame 316 is in the inactive state, all of the radar frames 322 associated with that feature frame 316 are also in the inactive state.

The pulse-mode feature frame 318 and the burst-mode feature frame 320 include different sequences of radar frames 322. Generally speaking, the radar frames 322 within an active pulse-mode feature frame 318 transmit pulses that are separated in time by a predetermined amount. This disperses observations over time, which can make it easier for the radar system 102 to recognize a gesture due to larger changes in the observed chirps 310-1 to 310-N within the pulse-mode feature frame 318 relative to the burst-mode feature frame 320. In contrast, the radar frames 322 within an active burst-mode feature frame 320 transmit pulses continuously across a portion of the burst-mode feature frame 320 (e.g., the pulses are not separated by a predetermined amount of time). This enables an active-burst-mode feature frame 320 to consume less power than the pulse-mode feature frame 318 by turning off a larger quantity of components, including those with longer start-up times, as further described below.

Within each active pulse-mode feature frame 318, the sequence of radar frames 322 alternates between the active state and the inactive state. Each active radar frame 322 transmits a chirp 310 (e.g., a pulse), which is illustrated by a triangle. A duration of the chirp 310 is characterized by an active time 328. During the active time 328, components within the transceiver 214 are powered-on. During a short-idle time 330, which includes the remaining time within the active radar frame 322 and a duration of the following inactive radar frame 322, the radar system 102 conserves power by turning off one or more active components within the transceiver 214 that have a start-up time within a duration of the short-idle time 330.

An active burst-mode feature frame 320 includes P active radar frames 322 and L-P inactive radar frames 322, where P is a positive integer that is less than or equal to L. To conserve power, the active radar frames 322-1 to 322-P occur prior to the inactive radar frames 322-(P+1) to 322-L. A duration of the inactive radar frames 322-(P+1) to 322-L is characterized by a long-idle time 332. By grouping the inactive radar frames 322-(P+1) to 322-L together, the radar system 102 can be in a powered-down state for a longer duration relative to the short-idle time 330 that occurs during the pulse-mode feature frame 318. Additionally, the radar system 102 can turn off additional components within the transceiver 214 that have start-up times that are longer than the short-idle time 330 and shorter than the long-idle time 332.

Each active radar frame 322 within an active burst-mode feature frame 320 transmits a portion of the chirp 310. In this example, the active radar frames 322-1 to 322-P alternate between transmitting a portion of the chirp 310 that increases in frequency and a portion of the chirp 310 that decreases in frequency.

The radar framing structure 312 enables power to be conserved through adjustable duty cycles within each frame type. A first duty cycle 334 is based on a quantity of active feature frames 316 (J) relative to a total quantity of feature frames 316 (K). A second duty cycle 336 is based on a quantity of active radar frames 322 (e.g., L/2 or P) relative to a total quantity of radar frames 322 (L). A third duty cycle 338 is based on a duration of the chirp 310 relative to a duration of a radar frame 322.

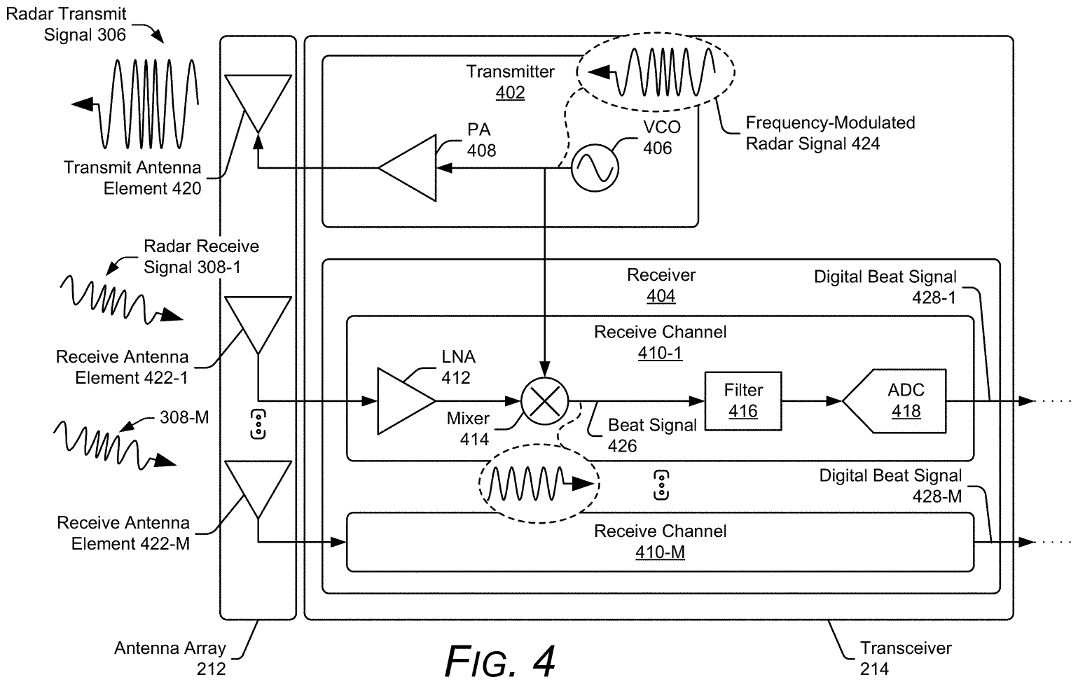

Consider an example radar framing structure 312 for a power state that consumes approximately 2 milliwatts (mW) of power and has a main-frame update rate between approximately 1 and 4 hertz (Hz). In this example, the radar framing structure 312 includes a main frame 314 with a duration between approximately 250 ms and 1 second. The main frame 314 includes thirty-one pulse-mode feature frames 318 (e.g., K is equal to 31). One of the thirty-one pulse-mode feature frames 318 is in the active state. This results in the duty cycle 334 being approximately equal to 3.2%. A duration of each pulse-mode feature frame 318 is between approximately 8 and 32 ms. Each pulse-mode feature frame 318 is composed of eight radar frames 322 (e.g., L is equal to 8). Within the active pulse-mode feature frame 318, all eight radar frames 322 are in the active state. This results in the duty cycle 336 being equal to 100%. A duration of each radar frame 322 is between approximately 1 and 4 ms. An active time 328 within each of the active radar frames 322 is between approximately 32 and 128 μs. As such, the resulting duty cycle 338 is approximately 3.2%. This example radar framing structure 312 has been found to yield good performance results. These good performance results are in terms of good near-range detection, gesture recognition, and presence detection while also yielding good power efficiency results in the application context of a handheld smartphone in a low-power state. Generation of the radar transmit signal 306 (of FIG. 3-1) and the processing of the radar receive signal 308 (of FIG. 3-1) are further described with respect to FIG. 4.

FIG. 4 illustrates an example antenna array 212 and an example transceiver 214 of the radar system 102. In the depicted configuration, the transceiver 214 includes a transmitter 402 and a receiver 404. The transmitter 402 includes at least one voltage-controlled oscillator 406 and at least one power amplifier 408. The receiver 404 includes at least two receive channels 410-1 to 410-M, where M is a positive integer greater than one. Each receive channel 410-1 to 410-M includes at least one low-noise amplifier 412, at least one mixer 414, at least one filter 416, and at least one analog-to-digital converter 418.

The antenna array 212 includes at least one transmit antenna element 420 and at least two receive antenna elements 422-1 to 422-M. The transmit antenna element 420 is coupled to the transmitter 402. The receive antenna elements 422-1 to 422-M are respectively coupled to the receive channels 410-1 to 410-M. Although the radar system 102 of FIG. 4 is shown to include multiple receive antenna elements 422-1 to 422-M and multiple receive channels 410-1 to 410-M, the described techniques for near-range detection can also be applied to radar systems 102 that utilize a single receive antenna element 422 and a single receive channel 410.

During transmission, the voltage-controlled oscillator 406 generates a frequency-modulated radar signal 424 at radio frequencies. The power amplifier 408 amplifies the frequency-modulated radar signal 424 for transmission via the transmit antenna element 420. The transmitted frequency-modulated radar signal 424 is represented by the radar transmit signal 306, which can include multiple chirps 310-1 to 310-N based on the radar framing structure 312 of FIG. 3-2. As an example, the radar transmit signal 306 is generated according to the burst-mode feature frame 320 of FIG. 3-2 and includes 16 chirps 310 (e.g., N equals 16).

During reception, each receive antenna element 422-1 to 422-M receives a version of the radar receive signal 308-1 to 308-M. In general, relative phase differences between these versions of the radar receive signals 308-1 to 308-M are due to differences in locations of the receive antenna elements 422-1 to 422-M. Within each receive channel 410-1 to 410-M, the low-noise amplifier 412 amplifies the radar receive signal 308, and the mixer 414 mixes the amplified radar receive signal 308 with the frequency-modulated radar signal 424. In particular, the mixer performs a beating operation, which downconverts and demodulates the radar receive signal 308 to generate a beat signal 426.

A frequency of the beat signal 426 represents a frequency difference between the frequency-modulated radar signal 424 and the radar receive signal 308, which is proportional to the slant range 304 of FIG. 3-1. Although not shown, the beat signal 426 can include multiple frequencies, which represents reflections from different portions of the user 302 (e.g., different fingers, different portions of a hand, or different body parts). In some cases, these different portions move at different speeds, move in different directions, or are positioned at different slant ranges relative to the radar system 102.

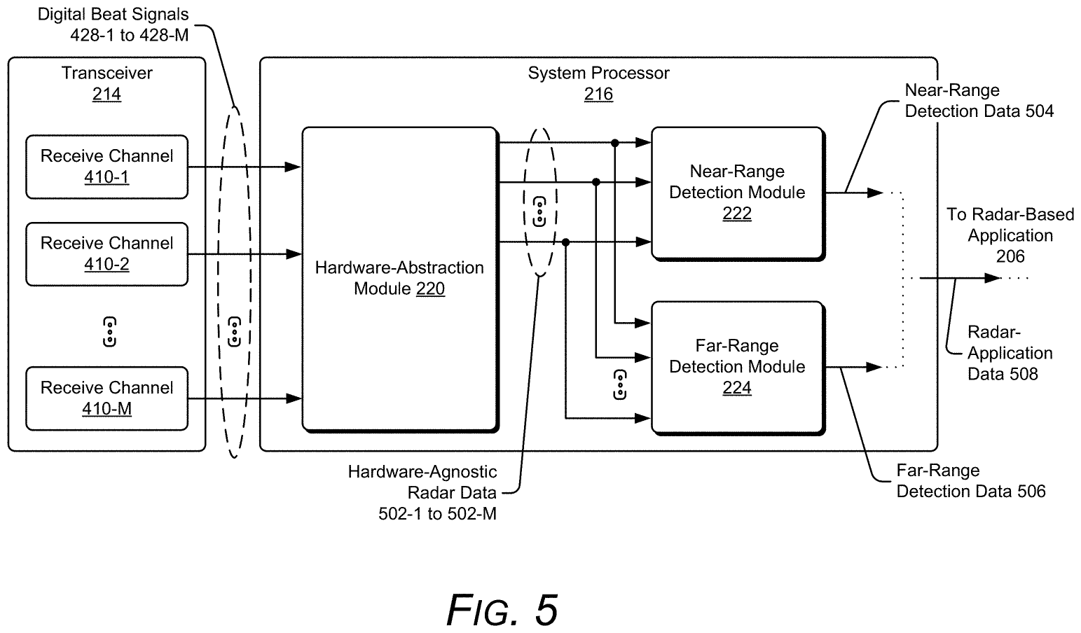

The filter 416 filters the beat signal 426, and the analog-to-digital converter 418 digitizes the filtered beat signal 426. The receive channels 410-1 to 410-M respectively generate digital beat signals 428-1 to 428-M, which are provided to the system processor 216 for processing. The receive channels 410-1 to 410-M of the transceiver 214 are coupled to the system processor 216, as shown in FIG. 5.

FIG. 5 illustrates an example scheme implemented by the radar system 102 for performing near-range detection. In the depicted configuration, the system processor 216 implements the hardware-abstraction module 220, the near-range detection module 222, and the far-range detection module 224. The system processor 216 is connected to the receive channels 410-1 to 410-M. The system processor 216 can also communicate with the computer processor 202 (of FIG. 2). Although not shown, the hardware-abstraction module 220, the near-range detection module 222, and/or the far-range detection module 224 can be implemented by the computer processor 202.

In this example, the hardware-abstraction module 220 accepts the digital beat signals 428-1 to 428-M from the receive channels 410-1 to 410-M. The digital beat signals 428-1 to 428-M represent raw or unprocessed complex radar data. The hardware-abstraction module 220 performs one or more operations to generate hardware-agnostic radar data 502-1 to 502-M based on digital beat signals 428-1 to 428-M. The hardware-abstraction module 220 transforms the complex radar data provided by the digital beat signals 428-1 to 428-M into a form that is expected by the near-range detection module 222 and the far-range detection module 224. In some cases, the hardware-abstraction module 220 normalizes amplitudes associated with different transmit power levels or transforms the complex radar data into a frequency-domain representation.

The hardware-agnostic radar data 502-1 to 502-M can include magnitude information or both magnitude and phase information (e.g., in-phase and quadrature components). In some implementations, the hardware-agnostic radar data 502-1 to 502-M includes range-Doppler maps for each receive channel 410-1 to 410-M and for a particular active feature frame 316, as further described with respect to FIGS. 6 and 7.

The near-range detection module 222 generates near-range detection data 504 based on the hardware-agnostic radar data 502-1 to 502-M. As an example, the near-range detection data 504 includes measured characteristics associated with one or more objects detected by the near-range detection module 222. The measured characteristics can include a signal-to-noise ratio, range, range rate, azimuth, or elevation of the one or more objects detected within the near-range interval.

The far-range detection module 224 generates far-range detection data 506 based on the hardware-agnostic radar data 502-1 to 502-M. As an example, the far-range detection data 506 includes measured characteristics associated with one or more objects detected by the far-range detection module 224. The measured characteristics can include a signal-to-noise ratio, range, range rate, azimuth, or elevation of the one or more objects detected within the far-range interval.

The near-range detection data 504 and the far-range detection data 506 can be provided to other modules within the radar system 102, such as a gesture-recognition module, a presence-detection module, a collision-avoidance module, a vital-sign measurement module, a tracking module, and so forth. These modules produce radar-application data 508, which is provided to the radar-based application 206 of FIG. 2-1. Generally, the techniques described above can be expanded to implement more than two detection modules for processing more than two different range intervals. Operation of the hardware-abstraction module 220 is further described with respect to FIG. 6.

FIG. 6 illustrates an example hardware-abstraction module 220 for performing near-range detection. In the depicted configuration, the hardware-abstraction module 220 includes a pre-processing stage 602 and a signal-transformation stage 604. The pre-processing stage 602 operates on each chirp 310-1 to 310-N within the digital beat signals 428-1 to 428-M. In other words, the pre-processing stage 602 performs an operation for each active radar frame 322. In this example, the pre-processing stage 602 includes M one-dimensional (1D) Fast-Fourier Transform (FFT) modules, which respectively process the digital beat signals 428-1 to 428-M. Other types of modules that perform similar operations are also possible, such as a Fourier Transform module.

For simplicity, the hardware-abstraction module 220 is shown to process a digital beat signal 428-1 associated with the receive channel 410-1. The digital beat signal 428-1 includes the chirps 310-1 to 310-M, which are time-domain signals. The chirps 310-1 to 310-M are passed to a one-dimensional FFT module 606-1 in an order in which they are received and processed by the transceiver 214. Assuming the radar receive signals 308-1 to 308-M include 16 chirps 310-1 to 310-N (e.g., N equals 16), the one-dimensional FFT module 606-1 performs 16 FFT operations to generate pre-processed complex radar data per chirp 612-1.

The signal-transformation stage 604 operates on the sequence of chirps 310-1 to 310-M within each of the digital beat signals 428-1 to 428-M. In other words, the signal-transformation stage 604 performs an operation for each active feature frame 316. In this example, the signal-transformation stage 604 includes M buffers and M two-dimensional (2D) FFT modules. For simplicity, the signal-transformation stage 604 is shown to include a buffer 608-1 and a two-dimensional FFT module 610-1.

The buffer 608-1 stores a first portion of the pre-processed complex radar data 612-1, which is associated with the first chirp 310-1. The one-dimensional FFT module 606-1 continues to process subsequent chirps 310-2 to 310-N, and the buffer 608-1 continues to store the corresponding portions of the pre-processed complex radar data 612-1. This process continues until the buffer 608-1 stores a last portion of the pre-processed complex radar data 612-1, which is associated with the chirp 310-M.

At this point, the buffer 608-1 stores pre-processed complex radar data associated with a particular feature frame 614-1. The pre-processed complex radar data per feature frame 614-1 represents magnitude information (as shown) and phase information (not shown) across different chirps 310-1 to 310-N and across different range bins 616-1 to 616-A, where A represents a positive integer.

The two-dimensional FFT 610-1 accepts the pre-processed complex radar data per feature frame 614-1 and performs a two-dimensional FFT operation to form the hardware-agnostic radar data 502-1, which represents a range-Doppler map 620. The range-Doppler map 620 includes complex radar data for the range bins 616-1 to 616-A and Doppler bins 618-1 to 618-B, where B represents a positive integer. In other words, each range bin 616-1 to 616-A and Doppler bin 618-1 to 618-B includes a complex number with real and imaginary parts that together represent magnitude and phase information. Each complex number is represented by a cell 622, which is associated with a particular range bin 616 and a particular Doppler bin 618. The quantity of range bins 616-1 to 616-A can be on the order of tens or hundreds, such as 64 or 128 (e.g., A equals 64 or 128). The quantity of Doppler bins can be on the order of tens or hundreds, such as 32, 64, or 124 (e.g., B equals 32, 64, or 124). As described above with respect to FIGS. 1 and 3-1, the range-Doppler map 620 can include a near-range interference artifact, as further described with respect to FIG. 7.

FIG. 7 illustrates an example range-Doppler map 620 for performing near-range detection. In this example, the amplitude (or magnitude) information of the hardware-agnostic radar data 502 is illustrated with different patterns. Larger amplitudes are represented with patterns that have a larger percentage of black. Smaller amplitudes are represented with patterns that have a smaller percentage of black (e.g., a higher percentage of white). Although not shown, the range-Doppler map 620 can also include phase information.

Each range bin 616 and Doppler bin 618 contains amplitude information for a particular range interval (e.g., slant-range interval or distance interval) and Doppler frequency interval. The range bins 616 are labeled from 1 to A. The Doppler bins 618 are labeled from −B/2 to 0 to B/2. The zero Doppler bin 618 includes amplitude information for objects that have a Doppler frequency of 0 Hz or a Doppler frequency equal to a multiple of the pulse repetition frequency (PRF). The ±B/2 bins include amplitude information for objects that have a Doppler frequency of ±PRF/2.

The range-Doppler map 620 includes a near-range portion 702 and a far-range portion 704. A first threshold range bin 706-1 indicates an upper boundary of the near-range portion 702. In the depicted configuration, the near-range portion 702 includes at least a portion of the range bins 616 between the first range bin 616-1 and the first threshold range bin 706-1. In other words, near-range portion 702 includes distances that are less than or equal to a first threshold and the far-range portion 704 includes distances that are greater than the first threshold.

As an example, the first threshold range bin 706-1 can be associated with a range (e.g., distance) that is on the order of centimeters, such as 10 centimeters, 15 centimeters, 20 centimeters, and so forth. The first threshold range bin 706-1 can be determined based on the internal interference 244 or the external interference 246 such that the near-range portion 702 includes distances that are greater than or equal to distances associated with one or more interference artifacts 716 generated by the internal interference 244 or the external interference 246. In some implementations, the far-range portion 704 includes a larger quantity of range bins 616 than the near-range portion 702.

In some cases, a second threshold range bin 706-2 defines a lower boundary of the near-range portion 702. In other words, the near-range portion 702 includes distances that are between a second threshold and the first threshold. As an example, the second threshold range bin 706-2 can be set such that the near-range portion 702 excludes range bins 616 that are associated with an interior of the smart device 104. For example, the second threshold range bin 706-2 can include a distance that is greater than or equal to a distance between the radar system 102 and the exterior viewing panel 226 or exterior housing 242 of FIG. 2-2. The second threshold range bin 706-2 can also be set to exclude range bins 616 associated with cross-coupling between antenna elements of the antenna array 212 (e.g., cross-coupling between the transmit antenna element 420 and one or more of the receive antenna elements 422-1 to 422-M of FIG. 4).

In this example, the radar receive signal 308 includes reflections from a near-range object 708 (e.g., a hand of the user 302) and reflections from a far-range object 710 (e.g., a body of the user 302). The far-range object 710 is moving and appears within high-Doppler bins 712 and the far-range portion 704 of the range-Doppler map 620. The near-range object 708 appears within low-Doppler bins 714 and the near-range portion 702 of the range-Doppler map 620. Generally, the low-Doppler bins 714 include Doppler bins 618 associated with a small percentage of the PRF, which correspond to relatively slow or stationary range rates. Example Doppler frequencies of the low-Doppler bins 714 can be less than or equal to 10% of the PRF, such as between approximately 0% and 5% of the PRF. The low-Doppler bins 714 can include the zero, positive one, and negative one Doppler bins 618, for instance. In some cases, the low-Doppler bins 714 can include additional Doppler bins 618, such as the positive two and negative two Doppler bins 618.

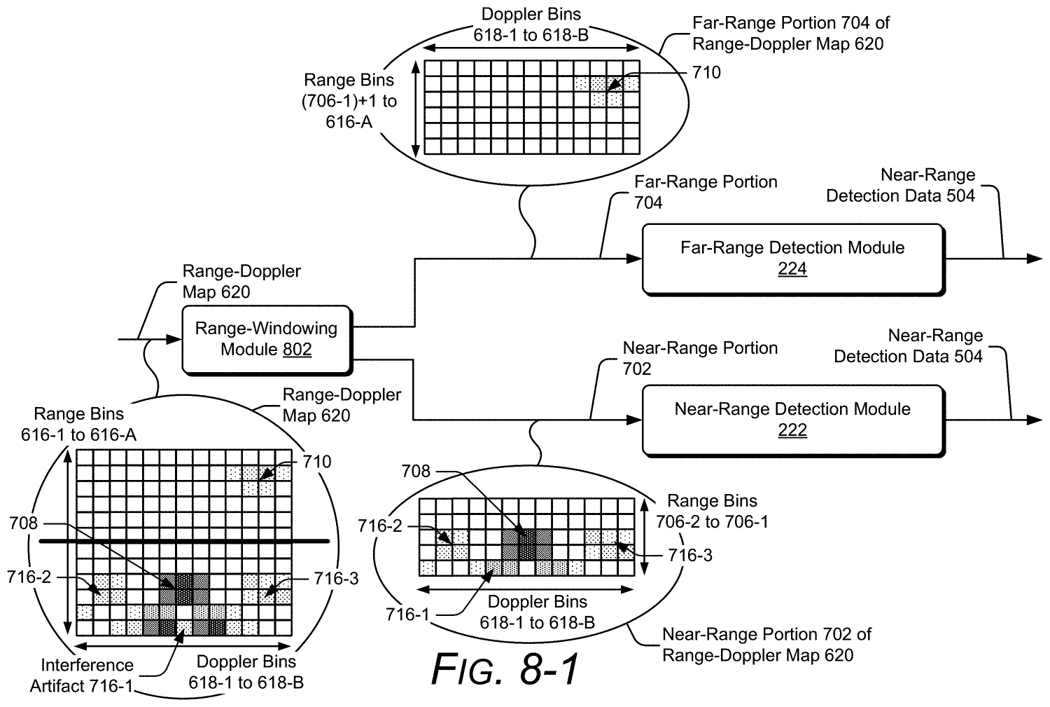

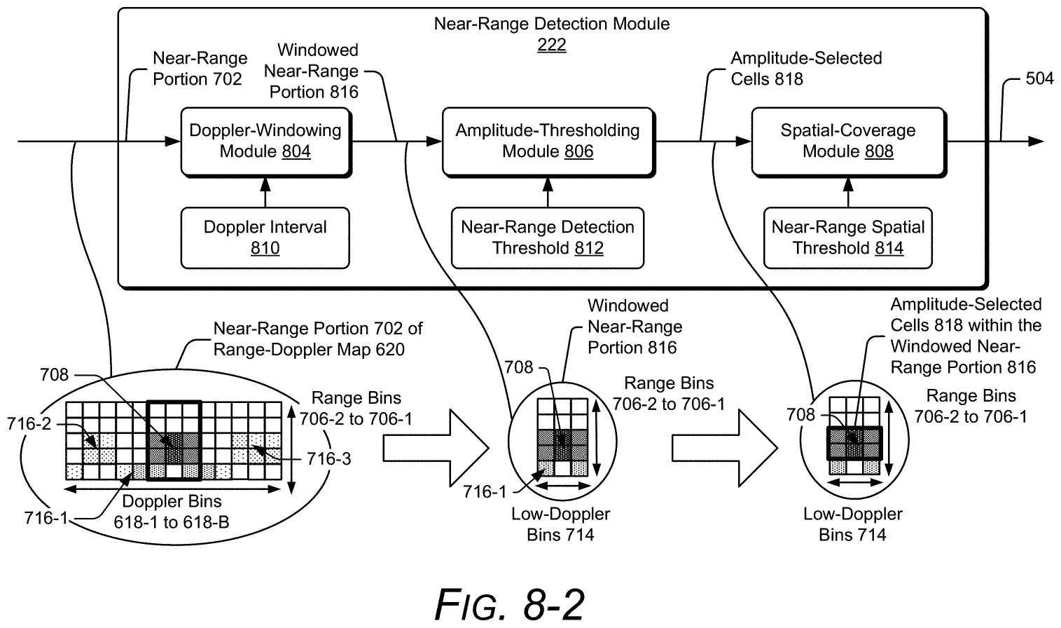

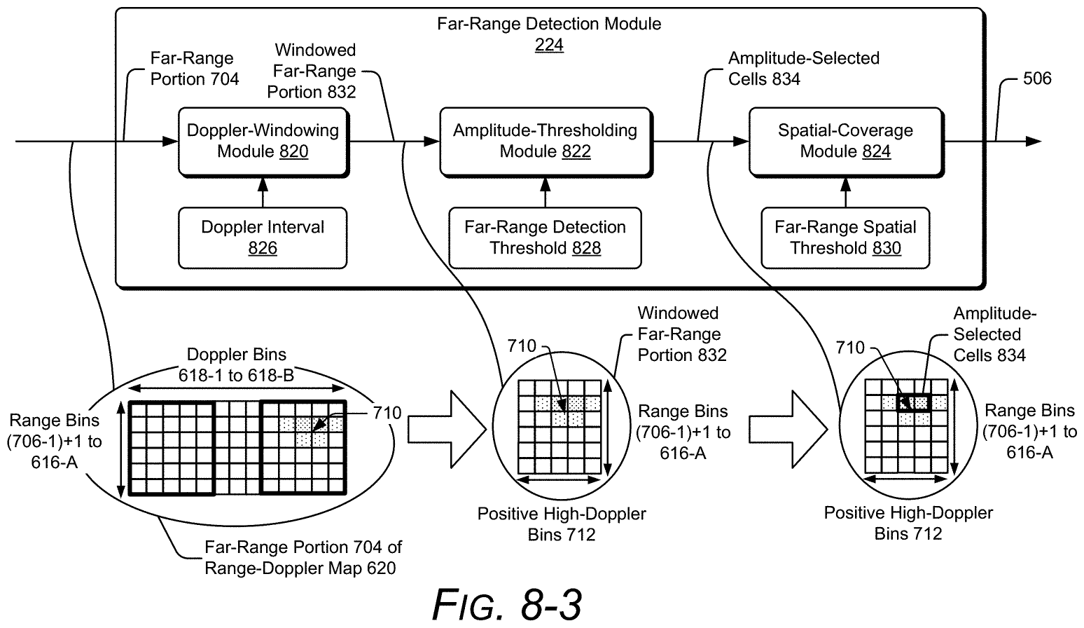

Due to the internal interference 244 or the external interference 246 detected by the radar system 102 (shown in FIG. 2-2), the range-Doppler map 620 also includes interference artifacts 716-1 to 716-3 within the near-range portion 702. The interference artifact 716-1 contributes to amplitudes within the first range bin 616-1 and the second threshold range bin 706-2, as well as amplitudes across the low-Doppler bins 714 and a portion of the high-Doppler bins 712. The interference artifact 716-2 contributes to amplitudes within the near-range portion 702 and a portion of the negative high-Doppler bins 712. The interference artifact 716-3 contributes to amplitudes within the near-range portion 702 and another portion of the positive high-Doppler bins 712. Both the near-range detection module 222 and the far-range detection module 224 analyze the range-Doppler map 620 to detect the near-range object 708 and the far-range object 710, respectively, as further described with respect to FIG. 8-1.

FIG. 8-1 illustrates an example scheme implemented by a range-windowing module 802, the near-range detection module 222, and the far-range detection module 224. An input of the range-windowing module 802 is coupled to the hardware-abstraction module 220 (of FIG. 6). An input of the near-range detection module 222 and an input of the far-range detection module 224 are coupled to respective outputs of the range-windowing module 802. Outputs of the near-range detection module 222 and the far-range detection module 224 can be coupled to other modules implemented by the system processor 216, as described above with respect to FIG. 2-1.

During operation, the range-windowing module 802 accepts the range-Doppler map 620 from the hardware-abstraction module 220. The range-windowing module 802 provides different portions of the range-Doppler map 620 to the near-range detection module 222 and the far-range detection module 224 based on the first threshold range bin 706-1 of FIG. 7. In particular, the range-windowing module 802 provides the near-range portion 702 of the range-Doppler map 620 to the near-range detection module 222 and the far-range portion 704 of the range-Doppler map 620 to the far-range detection module 224.

In this example, the near-range portion 702 of the range-Doppler map 620 includes the range bins 616 between the second threshold range bin 706-2 and the first threshold range bin 706-1. By setting the second threshold range bin 706-2 to be greater than the first range bin 616-1, large amplitudes associated with the interference artifact 716-1 within the range bin 616-1 are not included in the near-range potion 702. The near-range portion 702 includes a portion of the interference artifact 716-1, the interference artifact 716-2, the interference artifact 716-3, and the near-range object 708.

The far-range portion 704 of the range-Doppler map 620 includes range bins 616 that are greater than the first threshold range bin 706-1. In other words, the far-range portion 704 of the range-Doppler map 620 includes range bins 616 between the next range bin that is larger than the first threshold range bin 706-1 (e.g., range bin (706-1)+1) to the range bin 616-A.

As described above with respect to FIG. 5, the near-range detection module 222 processes the near-range portion 702 to generate the near-range detection data 504. The far-range detection module 224 processes the far-range portion 704 to generate the near-range detection data 504. Operations of the near-range detection module 222 and the far-range detection module 224 are further described with respect to FIGS. 8-2 and 8-3, respectively. To achieve a target false-alarm rate, the near-range detection module 222 can filter remaining portions of the interference artifacts 716-1 to 716-3 from the near-range portion 702 without attenuating the near-range object 708, as further described with respect to FIG. 8-2.

FIG. 8-2 illustrates an example implementation of the near-range detection module 222. The near-range detection module 222 includes at least one amplitude-thresholding module 806 and optionally includes at least one Doppler-windowing module 804 or at least one spatial-coverage module 808. In the depicted configuration, the near-range detection module 222 includes the Doppler-windowing module 804, the amplitude-thresholding module 806, and the spatial-coverage module 808. Each of these modules can operate on the hardware-agnostic radar data 502 provided by the hardware-abstraction module 220 or operate on other data that is provided by another one of the modules.

The Doppler-windowing module 804 filters the hardware-agnostic radar data 502 along the Doppler dimension according to a Doppler interval 810, which specifies a set of Doppler bins 618, such as the low-Doppler bins 714. The amplitude-thresholding module 806 identifies cells 622 with amplitudes that are greater than or equal to a near-range detection threshold 812. The near-range detection threshold 812 can be a constant-false-alarm-rate threshold and set based on a target false-alarm rate. In other words, the near-range detection threshold 812 can be set to be greater than an estimated amplitude of possible interference artifacts 716. The spatial-coverage module 808 compares a percentage of cells 622 with amplitudes that are greater than or equal to the near-range detection threshold 812 to a near-range spatial threshold 814. Responsive to the percentage being greater than or equal to the near-range spatial threshold 814, the spatial-coverage module 808 generates the near-range detection data 504, which indicates the presence of the near-range object 708. The near-range spatial threshold 814 can be set based on a size of the windowed far-range portion 832 and an expected size of an object within the near-range portion 702. As an example, the near-range spatial threshold 814 can be set to 50%.

Consider an example operation of the near-range detection module 222 given the range-Doppler map 620 of FIG. 7. During operation, the Doppler-windowing module 804 filters the near-range portion 702 of the range-Doppler map 620 to generate a windowed near-range portion 816, which includes the range bins 706-2 to 706-1 and the low-Doppler bins 714. By performing this operation, the Doppler-Windowing module 804 filters the interference artifacts 716-2 and 716-3 without attenuating the near-range object 708. A portion of the interference artifact 716-1 is also filtered.

The amplitude-thresholding module 806 identifies cells 622 with amplitudes that are greater than the near-range detection threshold 812. In this case, the amplitude-threshold module 806 identifies the cells 622 associated with the near-range object 708, as indicated by a box. This effectively filters the cells 622 associated with the interference artifact 716-1. The amplitude-threshold module 806 provides amplitude-selected cells 818 to the spatial-coverage module 808.

The spatial-coverage module 808 compares a percentage of the windowed near-range portion 816 that is associated with the amplitude-selected cells 818 to the near-range spatial threshold 814. If the percentage is greater than or equal to the near-range spatial threshold 814, the spatial-coverage module 808 generates the near-range detection data 504 based on the information contained within the amplitude-selected cells 818. In this way, the near-range detection module 222 detects the near-range object 708 and the near-range detection data 504 includes information associated with the near-range object 708. As an example, the near-range detection data 504 can include the range bin 616 and Doppler bin 618 associated with the highest amplitude within the amplitude-selected cells 818. While the near-range detection module 222 detects the near-range object 708, the far-range detection module 224 processes the far-range portion 704 of the range-Doppler map 620 to detect the far-range object 710, as further described with respect to FIG. 8-3.

FIG. 8-3 illustrates an example implementation of the far-range detection module 224. The far-range detection module 224 includes at least one amplitude-thresholding module 822. The far-range detection module 224 can also optionally include at least one Doppler-windowing module 820 or at least one spatial-coverage module 824. In the depicted configuration, the far-range detection module 224 includes the Doppler windowing module 820, the amplitude-thresholding module 822, and the spatial-coverage module 824. Each of these modules can operate on the hardware-agnostic radar data 502 provided by the hardware-abstraction module 220 or operate on other data that is provided by one of the modules.

The Doppler-windowing module 820 filters the hardware-agnostic radar data 502 along the Doppler dimension according to a Doppler interval 826, which specifies a set of Doppler bins 618, such as the high-Doppler bins 712. The amplitude-thresholding module 822 identifies cells 622 with amplitudes that are greater than or equal to a far-range detection threshold 828. The far-range detection threshold 828 can be a constant-false-alarm-rate threshold and set based on a target false-alarm rate. In some cases, the far-range detection threshold 828 and the near-range detection threshold 812 are the same. In other cases, the far-range detection threshold 828 is less than the near-range detection threshold 812. The spatial-coverage module 824 compares a percentage of cells 622 with amplitudes that are greater than or equal to the far-range detection threshold 828 to a far-range spatial threshold 830. Responsive to the percentage being less than or equal to the far-range spatial threshold 830, the spatial-coverage module 824 generates the far-range detection data 506, which indicates the presence of the far-range object 710. The far-range spatial threshold 830 can be smaller than the near-range spatial threshold 814. As an example, the far-range spatial threshold 830 can be set such that a detection is declared responsive to the amplitude-selected cells 834 including a few cells (e.g., one cell, two cells, or less than four cells).

Consider an example operation of the far-range detection module 224 given the range-Doppler map 620 of FIG. 7. During operation, the Doppler-windowing module 820 filters the far-range portion 704 of the range-Doppler map 620 to generate a windowed far-range portion 832, which includes the range bins (706-1)+1 to 706-A and the high-Doppler bins 712. Although the windowed far-range portion 832 is shown to include the positive high-Doppler bins 712 in FIG. 8-3, it is to be understood that the negative high-Doppler bins 712 can also be included within the windowed far-range portion 832. By performing this operation, the Doppler-windowing module 804 can filter any interference or clutter associated with the low-Doppler bins 714.

The amplitude-thresholding module 822 identifies cells 622 with amplitudes that are greater than the far-range detection threshold 828. In this case, the amplitude-threshold module 822 identifies a portion of the cells 622 associated with the far-range object 710, which are shown as amplitude-selected cells 834. The amplitude-threshold module 822 provides the amplitude-selected cells 834 to the spatial-coverage module 824.

The spatial-coverage module 824 compares a percentage of the windowed far-range portion 832 that is associated with the amplitude-selected cells 834 to the far-range spatial threshold 830. If the percentage is less than or equal to the far-range spatial threshold 830, the spatial-coverage module 808 generates the far-range detection data 506 based on the amplitude-selected cells 834. In this way, the far-range detection module 224 detects the far-range object 710 and the far-range detection data 506 includes information associated with the far-range object 710. The far-range detection data 506 can include the range bin 616 and Doppler bin 618 associated with the highest amplitude within the amplitude-selected cells 834.

Although described with respect to the range-Doppler map 620, the near-range Detection module 222 and the far-range detection module 224 can also perform similar operations on other types of data. In some implementations, for instance, a digital beamformer is connected to an output of the hardware-abstraction module 220. In this case, the near-range detection module 222 and the far-range detection module 224 can operate on maps with angular dimensions, which are generated by the digital beamformer. An example map can include a range-Doppler-azimuth-elevation map. In this case, the spatial-coverage modules 808 and 824 can be tailored to evaluate other spatial thresholds across an angular dimension.

Example Method

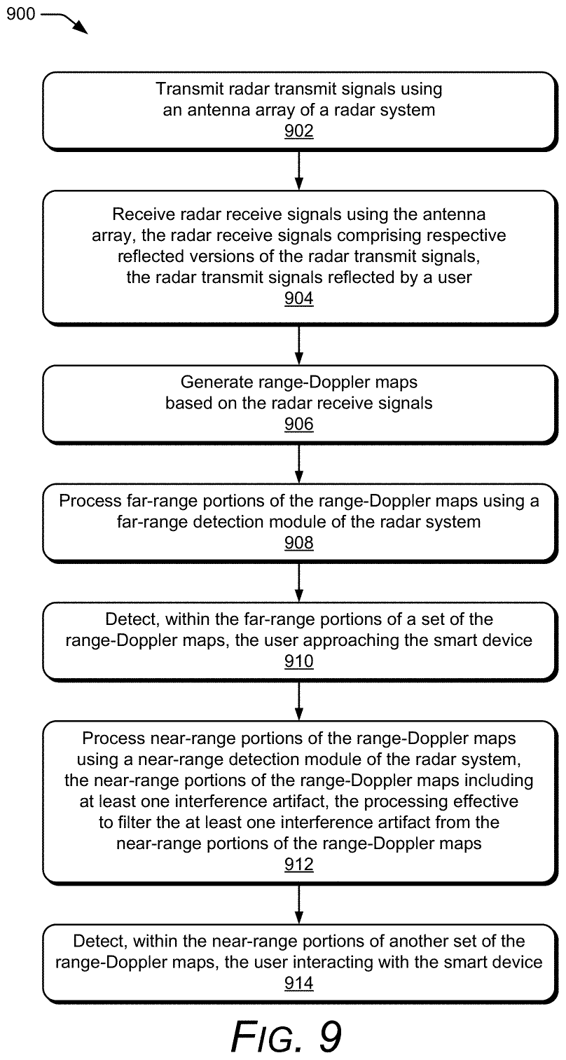

FIG. 9 depicts an example method 900 for performing operations of a smart-device-based radar system capable of near-range detection. Method 900 is shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100-1 to 100-6 of FIG. 1, and entities detailed in FIG. 2-1 or 5, reference to which is made for example only. The techniques are not limited to performance by one entity or multiple entities operating on one device.

At 902, radar transmit signals are transmitted using an antenna array of a radar system. For example, the antenna array 212 of the radar system 102 transmits radar transmit signals 306, as shown in FIG. 4.

At 904, radar receive signals are received using the antenna array. The radar receive signals comprise respective reflected versions of the radar transmit signals. The radar transmit signals are reflected by a user. For example, the antenna array 212 receives the radar receive signals 308, as shown in FIG. 4. The radar receive signals 308 include respective reflected versions of the radar transmit signals 306. The radar transmit signals 306 are reflected by the user 302.

At 906, range-Doppler maps are generated based on the radar receive signals. For example, the hardware-abstraction module 220 generates range-Doppler maps 620 based on the digital beat signals 428 associated with the radar receive signals 308. Each range-Doppler map 620 is associated with a particular pulse-mode feature frame 318 or burst-mode feature frame 320 within one of the radar receive signals 308.

At 908, far-range portions of the range-Doppler maps are processed using a far-range detection module of the radar system. For example, the far-range detection module 224 processes far-range portions 704 of the range-Doppler maps 620, as shown in FIG. 8-1.

At 910, the user is detected approaching the smart device within the far-range portions of a set of the range-Doppler maps. For example, the far-range detection module 224 detects, within the far-range portions 704 of a set of the range-Doppler maps 620, the user 302 approaching the smart device 104. In FIGS. 7 and 8-3, the far-range object 710 can represent a portion of the user 302 within the far-range interval.

At 912, near-range portions of the range-Doppler maps are processed using a near-range detection module of the radar system. The near-range portions of the range-Doppler maps include at least one interference artifact. The processing is effective to filter the at least one interference artifact from the near-range portions of the range-Doppler maps. For example, the near-range detection module 222 processes the near-range portions 702 of the range-Doppler maps 620, as shown in FIG. 8-1. The near-range portions 702 of the range-Doppler maps 620 include at least one interference artifact 716, such as the interference artifacts 716-1, 716-2, and/or 716-3 of FIG. 7. The processing is effective to filter the at least one interference artifact 716 from the near-range portions 702 of the range-Doppler maps 620, as shown in FIG. 8-2.

At 914, the user is detected interacting with the smart device within the near-range portions of another set of the range-Doppler maps. For example, the near-range detection module 222 detects the user 302 interacting with the smart device 104 within the near-range portions 702 of another set of the range-Doppler maps 620. The user 302 can be watching a movie on the smart device 104, performing a gesture to control a feature of the smart device 104, or physically interacting with the smart device 104. In FIGS. 7 and 8-2, the near-range object 708 can represent a portion of the user 302 within the near-range interval.

Example Computing System

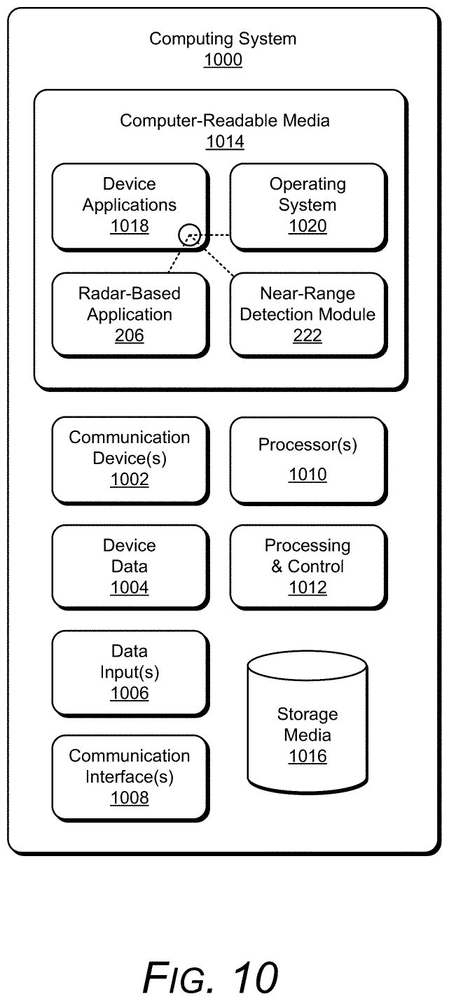

FIG. 10 illustrates various components of an example computing system 1000 that can be implemented as any type of client, server, and/or computing device as described with reference to the previous FIG. 2-1 to implement near-range detection.

The computing system 1000 includes communication devices 1002 that enable wired and/or wireless communication of device data 1004 (e.g., received data, data that is being received, data scheduled for broadcast, or data packets of the data). Although not shown, the communication devices 1002 or the computing system 1000 can include one or more radar systems 102. The device data 1004 or other device content can include configuration settings of the device, media content stored on the device, and/or information associated with a user 302 of the device. Media content stored on the computing system 1000 can include any type of audio, video, and/or image data. The computing system 1000 includes one or more data inputs 1006 via which any type of data, media content, and/or inputs can be received, such as human utterances, the radar-based application 206, user-selectable inputs (explicit or implicit), messages, music, television media content, recorded video content, and any other type of audio, video, and/or image data received from any content and/or data source.

The computing system 1000 also includes communication interfaces 1008, which can be implemented as any one or more of a serial and/or parallel interface, a wireless interface, any type of network interface, a modem, and as any other type of communication interface. The communication interfaces 1008 provide a connection and/or communication links between the computing system 1000 and a communication network by which other electronic, computing, and communication devices communicate data with the computing system 1000.

The computing system 1000 includes one or more processors 1010 (e.g., any of microprocessors, controllers, and the like), which process various computer-executable instructions to control the operation of the computing system 1000 and to enable techniques for, or in which can be embodied, gesture recognition in the presence of saturation. Alternatively or in addition, the computing system 1000 can be implemented with any one or combination of hardware, firmware, or fixed logic circuitry that is implemented in connection with processing and control circuits which are generally identified at 1012. Although not shown, the computing system 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1000 also includes a computer-readable media 1014, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1000 can also include a mass storage media device (storage media) 1016.

The computer-readable media 1014 provides data storage mechanisms to store the device data 1004, as well as various device applications 1018 and any other types of information and/or data related to operational aspects of the computing system 1000. For example, an operating system 1020 can be maintained as a computer application with the computer-readable media 1014 and executed on the processors 1010. The device applications 1018 may include a device manager, such as any form of a control application, software application, signal-processing and control module, code that is native to a particular device, a hardware abstraction layer for a particular device, and so on.

The device applications 1018 also include any system components, engines, or managers to implement near-range detection. In this example, the device applications 1018 includes the radar-based application 206 and the near-range detection module 222 of FIG. 2-1.

### Conclusion

Although techniques using, and apparatuses including, a smart-device-based radar system performing near-range detection have been described in language specific to features and/or methods, it is to be understood that the subject of the appended claims is not necessarily limited to the specific features or methods described. Rather, the specific features and methods are disclosed as example implementations of a smart-device-based radar system performing near-range detection.

Some examples are described below.

Example 1: A method performed by a radar system implemented within a smart device, the method comprising:

transmitting radar transmit signals using an antenna array of the radar system;

receiving radar receive signals using the antenna array, the radar receive signals comprising respective reflected versions of the radar transmit signals, the radar transmit signals reflected by a user;

generating range-Doppler maps based on the radar receive signals;

processing far-range portions of the range-Doppler maps using a far-range detection module of the radar system;

detecting, within the far-range portions of a set of the range-Doppler maps, the user approaching the smart device;

processing near-range portions of the range-Doppler maps using a near-range detection module of the radar system, the near-range portions of the range-Doppler maps including at least one interference artifact, the processing effective to filter the at least one interference artifact from the near-range portions of the range-Doppler maps; and

detecting, within the near-range portions of another set of the range-Doppler maps, the user interacting with the smart device.

Example 2: The method of example 1, wherein:

the near-range portions of the range-Doppler maps represent distances that are less than or equal to a threshold; and

the far-range portions of the range-Doppler maps include other distances that are greater than the threshold.

Example 3: The method of example 2, wherein the threshold corresponds to a distance that is less than or equal to twenty centimeters.

Example 4: The method of example 2 or 3, wherein the distances are greater than or equal to another threshold, the other threshold being less than the threshold.

Example 5: The method of example 4, wherein:

the threshold is greater than or equal to a distance associated with the at least one interference artifact; and

the other threshold is greater than or equal to another distance between the radar system and an exterior of the smart device.

Example 6: The method of any one of examples 2 to 5, wherein the near-range portions include a smaller quantity range bins than the far-range portions.

Example 7: The method of any preceding example, wherein:

the range-Doppler maps include a set of low-Doppler bins and a set of high-Doppler bins;

the at least one interference artifact is associated with at least one Doppler bin within the set of high-Doppler bins;

the processing of the far-range portions of the range-Doppler maps comprises analyzing the far-range portions of the range-Doppler maps that are associated with the set of high-Doppler bins; and

the processing of the near-range portions of the range-Doppler maps comprises analyzing the near-range portions of the range-Doppler maps that are associated with the set of low-Doppler bins to filter the at least one interference artifact.

Example 8: The method of any preceding example, wherein:

the processing of the far-range portions of the range-Doppler maps comprises:
comparing amplitudes of cells within the far-range portions of the range-Doppler maps to a far-range detection threshold;
detecting the user responsive to one or more of the cells having amplitudes that are greater than or equal to the far-range detection threshold; and/or the processing of the near-range portions of the range-Doppler maps comprises:
comparing amplitudes of other cells within the near-range portion of the range-Doppler maps to a near-range detection threshold, the near-range detection threshold being greater than the far-range detection threshold; and
detecting the user interacting with the smart device responsive to one or more of the other cells having amplitudes that are greater than or equal to the near-range detection threshold.

Example 9: The method of any of examples 1 to 7, wherein:

the processing of the far-range portions of the range-Doppler maps comprises:
comparing amplitudes of cells within the far-range portions of the range-Doppler maps to a far-range detection threshold;
determining a percentage of the cells that have amplitudes that are less than or equal to the far-range detection threshold; and
detecting the user responsive to the percentage of the cells being less than or equal to a far-range spatial threshold; and/or

the processing of the near-range portions of the range-Doppler maps comprises:
comparing amplitudes of other cells within the near-range portions of the range-Doppler map to a near-range detection threshold;
determining a percentage of the other cells that have amplitudes that are greater than or equal to the near-range detection threshold; and
detecting the user interacting with the smart device responsive to the percentage of the other cells being greater than or equal to a near-range spatial threshold.

Example 10: The method of example 9, wherein:

the near-range detection threshold is greater than the far-range detection threshold; or

the near-range detection threshold is equal to the far-range detection threshold.

Example 11: The method of any preceding example, wherein the interference artifact represents at least one of the following:

an audible sound; or

a wireless communication signal;

noise on a power line of the smart device that is connected to the radar system; or

cross-coupling within the antenna array of the radar system.

Example 12: The method of any preceding example, further comprising:

determining, prior to the processing of the near-range portions of the range-Doppler maps, whether the user is within a proximity of the smart device; and
responsive to the user being within the proximity, enabling the processing of the near-range portions of at least a portion of the range-Doppler maps; or
responsive to the user being outside the proximity, disabling the processing of the near-range portion of the range-Doppler maps.

Example 13: The method of example 0, wherein the determining that the user is within the proximity comprises:

determining that the user is approaching the smart device based on the processing of the far-range portions of the range-Doppler maps; or

detecting the user using a proximity sensor of the smart device.

Example 14: An apparatus comprising:

a radar system comprising:
an antenna array;
a transceiver; and
a processor and computer-readable storage media configured to perform any of the methods of examples 1 to 13.

Example 15: The apparatus of example 14, wherein the apparatus comprises a smart device, the smart device comprising one of the following:

a smartphone;

a smart watch;

a smart speaker;

a smart thermostat;

a security camera;

a vehicle; or

a household appliance.

1. A method performed by a radar system implemented within a smart device, the method comprising:
transmitting radar transmit signals using an antenna array of the radar system;
receiving radar receive signals using the antenna array, the radar receive signals comprising respective reflected versions of the radar transmit signals, the radar transmit signals reflected by a user;
generating range-Doppler maps based on the radar receive signals;
processing far-range portions of the range-Doppler maps using a far-range detection module of the radar system;
detecting, within the far-range portions of a set of the range-Doppler maps, the user approaching the smart device;
processing near-range portions of the range-Doppler maps using a near-range detection module of the radar system, the near-range portions of the range-Doppler maps including at least one interference artifact, the processing effective to filter the at least one interference artifact from the near-range portions of the range-Doppler maps; and
detecting, within the near-range portions of another set of the range-Doppler maps, the user interacting with the smart device.

2. The method of claim 1, wherein:
the near-range portions of the range-Doppler maps include distances that are less than or equal to a threshold; and
the far-range portions of the range-Doppler maps include other distances that are greater than the threshold.

3. The method of claim 2, wherein the threshold corresponds to a distance that is less than or equal to twenty centimeters.

4. The method of claim 2, wherein the distances are greater than or equal to another threshold, the other threshold being less than the threshold.

5. The method of claim 4, wherein:
the threshold is greater than or equal to a distance associated with the at least one interference artifact; and
the other threshold is greater than or equal to another distance between the radar system and an exterior of the smart device.

6. The method of claim 2, wherein the near-range portions include a smaller quantity range bins than the far-range portions.

7. The method of claim 1, wherein:
the range-Doppler maps include a set of low-Doppler bins and a set of high-Doppler bins;
the at least one interference artifact is associated with at least one Doppler bin within the set of high-Doppler bins;
the processing of the far-range portions of the range-Doppler maps comprises analyzing the far-range portions of the range-Doppler maps that are associated with the set of high-Doppler bins; and
the processing of the near-range portions of the range-Doppler maps comprises analyzing the near-range portions of the range-Doppler maps that are associated with the set of low-Doppler bins to filter the at least one interference artifact.

8. The method of claim 1, wherein: the processing of the far-range portions of the range-Doppler maps comprises:
comparing amplitudes of cells within the far-range portions of the range Doppler maps to a far-range detection threshold; and
detecting the user responsive to one or more of the cells having amplitudes that are greater than or equal to the far-range detection threshold; the processing of the near-range portions of the range-Doppler maps comprises:
comparing amplitudes of other cells within the near-range portion of the range-Doppler maps to a near-range detection threshold, the near-range detection threshold being greater than the far-range detection threshold; and
detecting the user interacting with the smart device responsive to one or more of the other cells having amplitudes that are greater than or equal to the near-range detection threshold; and
the at least one interference artifact has an amplitude that is less than the near-range detection threshold and greater than the far-range detection threshold.

9. The method of claim 1, wherein:
the processing of the far-range portions of the range-Doppler maps comprises:
comparing amplitudes of cells within the far-range portions of the range Doppler maps to a far-range detection threshold;
determining a percentage of the cells that have amplitudes that are less than or equal to the far-range detection threshold; and
detecting the user responsive to the percentage of the cells being less than or equal to a far-range spatial threshold;
the processing of the near-range portions of the range-Doppler maps comprises:
comparing amplitudes of other cells within the near-range portions of the range-Doppler map to a near-range detection threshold;
determining a percentage of the other cells that have amplitudes that are greater than or equal to the near-range detection threshold; and
detecting the user interacting with the smart device responsive to the percentage of the other cells being greater than or equal to a near-range spatial threshold.

10. The method of claim 9, wherein:
the near-range detection threshold is greater than the far-range detection threshold; or
the near-range detection threshold is equal to the far-range detection threshold.

11. The method of claim 1, wherein the interference artifact represents at least one of the following:
an audible sound;
a wireless communication signal;
noise on a power line of the smart device that is connected to the radar system; or
cross-coupling within the antenna array of the radar system.

12. The method of claim 1, further comprising:
determining, prior to the processing of the near-range portions of the range-Doppler maps, whether the user is within a proximity of the smart device; and
responsive to the user being within the proximity, enabling the processing of the near-range portions of at least a portion of the range-Doppler maps; or
responsive to the user being outside the proximity, disabling the processing of the near-range portion of the range-Doppler maps.

13. The method of claim 12, wherein the determining that the user is within the proximity comprises:
determining that the user is approaching the smart device based on the processing of the far-range portions of the range-Doppler maps; or
detecting the user using a proximity sensor of the smart device.

14. An apparatus comprising:
a radar system comprising:
an antenna array;
a transceiver coupled to the antenna array and configured to:
transmit radar transmit signals using the antenna array;
receive radar receive signals using the antenna array, the radar receive signals comprising respective reflected versions of the radar transmit signals, the radar transmit signals reflected by a user; and
a processor and computer-readable storage media configured to:
generate range-Doppler maps based on the radar receive signals;
implement a far-range detection module configured to:
process far-range portions of the range-Doppler maps; and
detect, within the far-range portions of a set of the range-Doppler maps, the user approaching the apparatus; and
implement a near-range detection module configured to:
process near-range portions of the range-Doppler maps to filter at least one interference artifact that is present within the near-range portions of the range-Doppler maps; and
detect, within the near-range portions of another set of the range-Doppler maps, the user interacting with the apparatus.

15. The apparatus of claim 14, wherein the apparatus comprises a smart device, the smart device comprising one of the following:
a smartphone;
a smart watch;
a smart speaker;
a smart thermostat;
a security camera;
a vehicle; or
a household appliance.

16. The apparatus of claim 14, wherein:
the near-range portions of the range-Doppler maps include distances that are less than or equal to a threshold; and
the far-range portions of the range-Doppler maps include other distances that are greater than the threshold.

17. The apparatus of claim 16, wherein the threshold corresponds to a distance that is less than or equal to twenty centimeters.

18. The apparatus of claim 14, wherein:
the range-Doppler maps include a set of low-Doppler bins and a set of high-Doppler bins;
the at least one interference artifact is associated with at least one Doppler bin within the set of high-Doppler bins;
the far-range detection module is configured to analyze the far-range portions of the range-Doppler maps that are associated with the set of high-Doppler bins; and
the near-range detection module is configured to analyze the near-range portions of the range-Doppler maps that are associated with the set of low-Doppler bins to filter the at least one interference artifact.

19. The apparatus of claim 14, wherein:
the far-range detection module is configured to:
compare amplitudes of cells within the far-range portions of the range Doppler maps to a far-range detection threshold; and
detect the user responsive to one or more of the cells having amplitudes that are greater than or equal to the far-range detection threshold;
the near-range detection module is configured to:
compare amplitudes of other cells within the near-range portion of the range-Doppler maps to a near-range detection threshold, the near-range detection threshold being greater than the far-range detection threshold; and
detect the user interacting with the apparatus responsive to one or more of the other cells having amplitudes that are greater than or equal to the near-range detection threshold; and
the at least one interference artifact has an amplitude that is less than the near-range detection threshold and greater than the far-range detection threshold.

20. The apparatus of claim 14, wherein the processor and computer-readable storage media are configured to:
Determine whether the user is within a proximity of the apparatus; and
responsive to the user being within the proximity, enabling the near-range detection module; or
responsive to the user being outside the proximity, disabling the near-range detection module.
